(19) United States
(12) Patent Application Publication
(10) Pub. No.: US 2003/0223002 A1
(43) Pub. Date: Dec. 4, 2003

(54) Camera body and a detachably coupled digital photography camera back

(76) Inventors: Hiroaki Minami, Osaka (JP); Tsutomu Ichikawa, Osaka (JP); Noriyuki Ishii, Osaka (JP); Hiroshi Ueda, Osaka (JP); Kenichi Ozaki, Osaka (JP)

Correspondence Address: MCDERMOTT WILL & EMERY, 600 13TH STREET, N.W., WASHINGTON, DC, 20005-3096, US

(21) Appl. No.: 10/397,844

(22) Filed: Mar. 27, 2003

(30) Foreign Application Priority Data
Mar. 27, 2002 (JP) 2002-088106(PAT.)
Mar. 27, 2002 (JP) 2002-088107(PAT.)
Apr. 12, 2002 (JP) 2002-111095(PAT.)

(51) Int. Cl. H04N 5/335

(52) U.S. Cl. 348/275

(57) ABSTRACT

A photographic camera having a camera body which is originally formatted for a film photography, i.e. the photography with a silver haloid film, and is selectively and detachably coupled with a camera back for the film photography (hereinafter referred to as a first camera back) and a camera back for digital photography with image pickup element or device, such as a CCD (hereinafter referred to as a second camera back). The camera body may adjusts photographic conditions in accordance with data of image pickup element mounted on the digital camera back. The camera body may alternatively which controls a range of photographic conditions in accordance with data of image pickup element mounted on the digital camera back.

This application is based on patent application Nos. 2002-88106, 2002-88107 and 2002-111095 filed in Japan, the contents of which are hereby incorporated by references.

### BACKGROUND OF THE INVENTION

1. Field of the Invention

The present invention relates to a photographic camera having a camera body which is originally formatted for a film photography, i.e. the photography with a silver haloid film, and is selectively and detachably coupled with a camera back for the film photography (hereinafter referred to as a first camera back) and a camera back for digital photography with image pickup element or device, such as a CCD and an image pickup tube (hereinafter referred to as a second camera back). The present invention also relates to the second camera back to be detachably coupled with the camera body as well as a camera system composed of the camera body and the second camera back.

2. Description of Related Art

A camera is known which has a film-formatted camera body having a construction to be coupled with a digital camera back (second camera back) for digital or electronic photography, in place of a film camera back (first camera back) for the film photography. Some of film cameras generally have sophisticated mechanism and are to be coupled with high quality objective lenses which may be made use of for digital or electronic photography when a second camera back is attached to the camera body.

When such a camera body is used with the second camera back for the digital photography, photographic conditions such as a diaphragm aperture or in-focus range must be adjusted in accordance with the size of the image pickup element and/or its pixel size mounted on the second camera back. However, it has been troublesome to adjust the photographic conditions with the known camera. It is to be understood that the image pickup element may be either a solid-state imaging element or device such as a CCD, or an image pickup tube, but that a solid-state imaging element is usually used for the second camera back. Thus, the following discussion will be made with reference to the solid-state imaging element or device.

In general, the size of the solid-state imaging element and/or its pixel size varies with the camera back and it is necessary to adjust the photographic condition in accordance with such varying size of the solid state imaging element and/or its pixel size.

A Japanese laid-open patent application with laid-open number Hei 11-288018 discloses a camera in which, when a second camera back is coupled with a camera body, a picture is taken with the diaphragm aperture fully open to avoid vignette which may occur in the case of picture-taking with the second camera back with the diaphragm is stopped-down to a certain aperture. Other Japanese laid-open patent applications with laid-open numbers Hei 11-164248 and 2000-267184 disclose cameras in which, when a second camera back is coupled with a camera body, successive photography is prevented or the cycle of the successive photography is limited in accordance with the capacity of a memory for storing image data of the taken picture. Here, the successive photography is a mode of camera operation with which a plurality of pictures are taken successively in response to a single release operation.

In digital cameras dedicated for the electronic or digital photography with the solid state imaging element, exposure conditions such as shutter speed, diaphragm aperture and ISO sensitivity, are settable within ranges adapted for the solid state imaging element in use.

In the prior art cameras of which camera body is detachably coupled with a second camera body, the ranges of the photographic conditions adapted for photography with a silver haloid film are applied to even when the second camera back is attached to the camera body, except that the diaphragm aperture is fully open at the time of the digital photography as mentioned above. However, if the photographic conditions for the digital photography are set or determined within the range adapted for the film photography, the resultant picture may not be one as intended by the user, or the user may lose a chance to take a picture at desired moment.

In the case of the successive photography, the time required between camera exposures is different in the case of the film photography and in the case of the digital photography. In the case of the film photography, camera mechanism are charged and a film is wound up during the time between an exposure and next exposure. In the case of digital photography, it take time for processing of an image data during that time. If the camera body is designed to have cycles of successive photography adapted for the photography which requires longer time between the exposures. However, in that case, the successive photography can not be made efficiently for the photography requiring shorter time between the exposures.

Further it is not always easy for the user to set exposure conditions taking into consideration the size of the solid state imaging element and/or its pixel.

In conventional cameras, data of photographic conditions with which a picture is taken, are stored in a memory device such as an EEPROM of a camera body and displayed on the camera body. However, such data of photographic condition is not associated with the image data produced by the second camera back.

When a picture is taken with the second camera body attached to the camera body for the digital photography, the image data produced by the solid state imaging device are stored in a memory such as a memory card mounted on the second camera back.

It is preferable if the data of the photographic conditions are associated with the image data of the picture taken with those photographic condition. However, conventional cameras lack or are poor in the function of such association.

### SUMMARY OF THE INVENTION

An object of the present invention is to provide an improved camera body which is formatted for photography with a silver haloid film and is detachably coupled with a camera back for digital photography.

Another object of the present invention is to provide a film-formatted camera body adapted for digital photography with a camera back having electronic or digital photography function attached to the camera body.

Still another object of the present invention is to provide a camera body which is detachably coupled with a digital camera back for digital photography and which adjusts photographic conditions in accordance with data of solid state imaging element mounted on the digital camera back.

Yet another object of the present invention is to provide a camera body which is detachably coupled with a digital camera back for digital photography and which controls a range of photographic conditions in accordance with data of solid state imaging element mounted on the digital camera back.

Yet still another object of the present invention, is to provide a camera body which is detachably coupled with a digital camera back for digital photography and which provides data of photographic conditions in association with an image data of the picture taken with the photographic conditions.

Further object of the present invention is to provide an improved camera back to be detachably coupled with a film formatted camera body for digital photography.

According to an aspect of the present invention, a camera body to be alternatively coupled with a first camera back for photography with a silver haloid film and a second camera back provided with an image pickup element for electronic photography, comprises an element data capturing unit for capturing data of the image pickup element; and a photographic condition control unit for controlling the determination of photographic condition in accordance with the data of the image pickup element.

According to another aspect of the present invention, a camera body to be alternatively coupled with a first camera back for photography with a silver haloid film and a second camera back provided with an image pickup element for electronic photography, comprises an element data capturing unit for capturing data of the image pickup element; and exposure condition range controlling unit for controlling range of exposure conditions in accordance with the data of the image pickup element.

According to yet another aspect of the present invention, a camera body to be alternatively coupled with a first camera back for photography with a silver haloid film and a second camera back provided with an image pickup element for electronic photography, comprises a photographic condition determining unit for determining photographic condition; a second camera back detecting unit for detecting whether the second camera back is attached to the camera body, an adjustment data output section through which a data for adjustment of the camera body is outputted to an camera adjusting device; and a photographic condition output unit for outputting the data of the photographic condition to the second camera back through the adjustment data output section.

According to further aspect of the present invention, a digital photography camera back to be attached to a camera body instead of a film photography camera back, comprises an image pickup element for producing image data for electronic photography; a data input section to be connected with an adjustment data output section of the camera body through which a data for adjustment of the camera body is outputted to an camera adjusting device; and a photographic data capturing unit for capturing the data of the photographic condition from the camera body through the data input section.

The above and further objects and novel features of the invention will more fully appear from the following detailed description wherein the same is read in connection with the accompanying drawing. It is to be expressly understood, however, that the drawing is for purpose of illustration only and is not intended as a definition of the limits of the invention.

### BRIEF DESCRIPTION OF THE DRAWINGS

FIG. 1 is a block diagram showing main components of a camera body according to a first embodiment of the present invention;

FIG. 2 is a block diagram showing main components of an exemplary camera back provided with an electronic imaging device and is to be coupled with the camera body for digital photography;

FIG. 3 shows electric connection between the camera body and the second camera back 2 for the digital photography;

FIG. 4 illustrates structure of a camera back 3 attached to the camera body 1 for the photography with a silver haloid film;

FIG. 5 shows exemplary structure of the second camera back 2 which is to be coupled with the camera body 1 instead of the first camera back 3;

FIG. 6 shows the construction of the state where the second camera back 2 is coupled to the camera body 1 wherein FIG. 6A is a back elevation of that combination, FIG. 6B is a partially sectional top view of the combination, and FIG. 6C is a top view of a dial type switch operator;

FIG. 7 shows main functional blocks of the camera CPU 116 provided in the camera body 1;

FIG. 8 is a flowchart roughly showing an exemplary operation of the camera body 1;

FIG. 9 shows an exemplary arrangement of the light measuring areas by means of the light measuring unit 104 when the first camera back 3 is coupled to the camera body 1;

FIG. 10 is a flowchart showing an exemplary light measuring operation made at Step #9 in FIG. 8;

FIG. 11 shows an exemplary arrangement of light measuring areas at the light measuring unit 104 when the second camera back 2 is attached to the camera body 1;

FIG. 12 is a flowchart showing in more detail the AF operation executed at Sep #11;

FIG. 13 shows an example of a table showing the relationship between the size of the CCD and the size of a pixel of the CCD and the in-focus range TH;

FIG. 14 is a flowchart showing in more detail an example of the exposure operation executed at Step #19 of FIG. 8;

FIG. 15 shows, by for example, a portion of a table showing the relationship between the sharing coefficient α and the image magnification β and the focal length f1 of the camera objective lens;

FIG. 16 shows an example of the program chart, with the abscissa representing the time value TV while the ordinate representing the aperture value AV;

FIG. 17 is a block diagram showing main functional components of the camera body 1 according to a second embodiment of the present invention;

FIG. 18 is for the explanation of the image circle, wherein FIG. 18A shows the case where the size of each pixel of the CCD is small, while FIG. 18B shows the case where the size of each pixel of the CCD is large;

FIG. 19 is a flowchart showing an exemplary operation of the camera body 1;

FIG. 20 is a flow chart showing the operation for adjusting the photographic conditions;

FIG. 21 is a block diagram showing main components of the camera body 1 and the second back 2 according to a third embodiment of the present invention;

FIG. 22 is a flow chart showing an exemplary operation of the camera body 1 executed by the camera CPU 116 when the second camera back 2 is attached to the camera body 1;

FIG. 23 is a flow chart showing an exemplary operation of the second camera back 2 attached to the camera body 1; and

FIG. 24 shows an example of the display displayed on the monitor screen 204 of the second camera back by the display control unit 251.

### DETAILED DESCRIPTION OF THE PREFERRED EMBODIMENTS

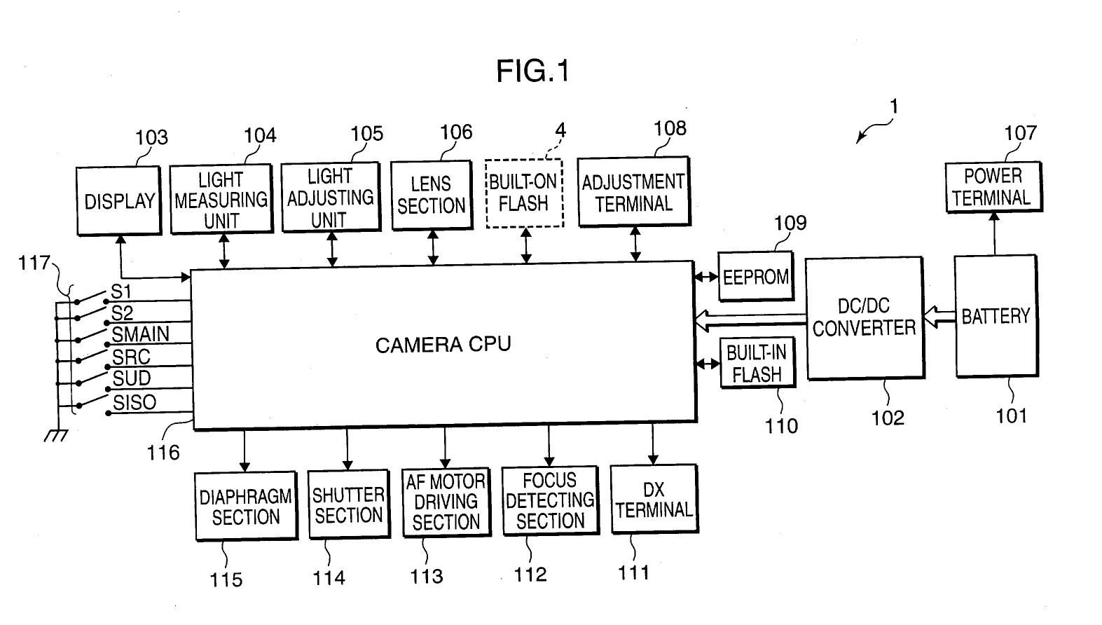

FIG. 1 is a block diagram showing main components of a camera body according to a first embodiment of the present invention. The camera body 1 is designed for photography with a silver haloid film and functions as a silver haloid camera or an ordinary film camera with a first camera back (explained later) attached to the camera body. The camera body functions as a digital camera with a second camera back (described later) attached to the camera body. The camera body in the present embodiment is of a single lens reflex type having sophisticated mechanism as is known in the art.

The camera body 1 comprises a battery 101 for supplying electric power to various parts of the camera body, a DC/DC converter 102 for converting the voltage supplied from the battery 101 to a predetermined level of voltage, a display 103 for displaying various data and information including photographic conditions, a light measuring unit 104 for measuring brightness of an objected to be photographed, a light adjusting unit 105 for adjusting light emitted from an electronic flash device measuring the flash light reflected by the object, and an objective lens section 106 for focusing the light rays from the object on a focal plane of the camera body 1. The camera body 1 further comprises power terminals 107 for outputting the electric power therethrough, adjustment terminals 108 for transmitting data, EEPROM 109 for storing data of various adjustment values, a built-in flash 110 for illuminating the object, DX terminals 111 for detecting DX code on a film cartridge held in the camera body, a focus detecting section 112 for detecting amount of out-of-focus, an AF motor driving section 113 having a AF motor for driving the objective lens, a shutter section 114 including a shutter mechanism and shutter control for controlling shutter speed, a diaphragm section 115 including a diaphragm mechanism and diaphragm control for controlling diaphragm aperture, a camera CPU 116 for controlling operations of various parts of the camera body 1, and a switch section 117 to be operated from outside.

A built-on flash 4 may be attached to the camera body in addition to the built-in flash 110. The built-on flash 4 generally emits larger amount of light than the built-in flash and the direction of the light emitted from the built-on flash may be changed.

The battery 101 supplies electric power to various part of the camera body 1 and other parts through the DC/DC converter 102 which in turn converts the voltage supplied from the battery 101 to a predetermined level of voltage to be fed to various parts of the camera body 1.

Display 103 is composed of, for example, LCD and displays various data and information including the photographic conditions, in response to commands from the CPU 116. The light measuring unit 104 includes a photoelectric element for measuring brightness of an object to be photographed and outputs the measurement data to the camera CPU 116. The light adjusting unit 105 measures the flash light emitted by the built-in and/or built-on flashes and reflected by the object, and outputs the measurement data to the camera CPU 116.

Lens section 106 includes an interchangeable objective lens and may be, for example, an electrically driven zoom lens, including a lens memory for storing lens data including data of the focal length of the lens. The data stored in the lens memory are outputted to the camera CPU 116. As an alternative, the objective lens may be fixedly coupled with the camera body 1. The data stored in the lens memory includes data representing an amount of lens movement in the direction of the optical axis of the lens, per one rotation of the AF motor of the AF motor driving section 113.

The power terminals 107 are for supplying the electric power of the battery 101 to the first or second camera back which will be described later. The adjustment terminals 108 are for communication with various adjusting units and accessories and are used, in the present embodiment, for the communication between the camera CPU and the second camera back. The adjusting units are connected with the camera body 1 during production of the camera body or after completion of the production of the camera body 1 to output data to be written in the camera body 1 in order to measure, in accordance with output signals from the camera body 1, individual characteristics of shutter mechanism and/or diaphragm mechanism by making test exposure operation in order that the individual characteristics are adjusted to be within a given tolerance.

EEPROM 109 is a rewritable non-volatile memory for storing various adjustment values and correction values supplied from the camera CPU 116. The adjustment value stored in the EEPROM 109 are shutter speed of the range 30 seconds through 1/8000, diaphragm aperture ranging from the full aperture to minimum aperture, and IOS sensitivity ranging from ISO 6 through 6400.

The built-in flash 110 is a light emitting unit composed of a charging circuit, a light control circuit, and a light emitting unit for illuminating the object to be photographed. DX terminals 111 are normally used to detect DX code on a film cartridge held in the camera body and are also used for the communication between the camera CPU 116 and the second camera back.

The focus detecting section 112 detects focus condition of the objective lens by phase difference detection system and output resultant data to the camera CPU 116. AF motor driving section 113 is composed of a motor such as a DC motor or a stepping motor, and a reduction mechanism for transmitting the rotation of the motor, reducing the rotational speed of the motor. The focus detecting section 112 drives the objective lens of the lens section 106 in accordance with the command of the camera CPU 116 to focus the objective lens. The shutter section 114 is provided with a mechanical shutter and a shutter drive section to control time of exposure i.e. shutter speed in accordance with a command of the camera CPU 116.

The diaphragm section 115 is provided with a diaphragm mechanism and its driving section to control a diaphragm aperture in accordance with a command of the camera CPU 116.

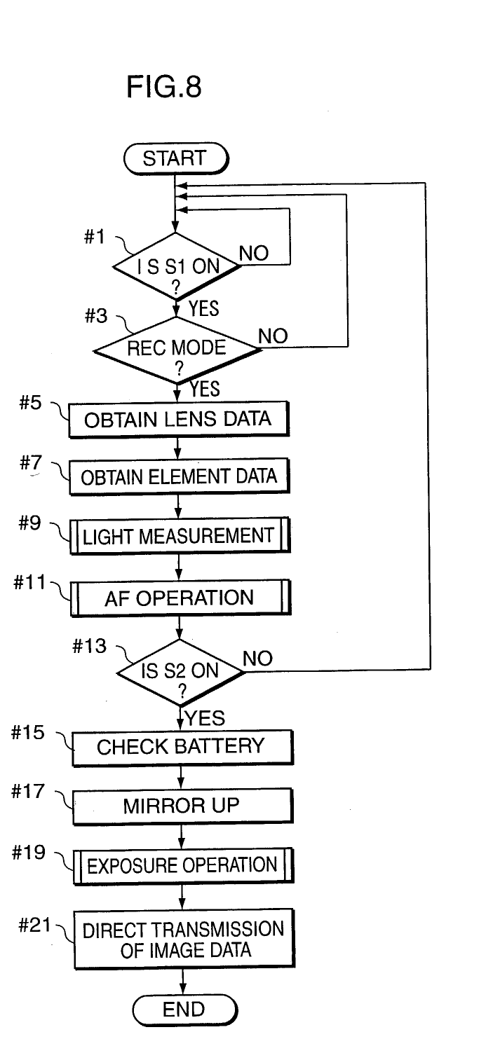

The camera CPU 116 is for controlling operations of the camera body 1 including the light measurement, focus detection, camera exposure and the like, and performs the control operation by executing a program in accordance with the various adjustment parameters stored in the EEPROM 109. In the present embodiment, the camera CPU 116 includes a CPU (Central Processing Unit), ROM and RAM such that the control operation is made by the CPU which executes a program stored in the ROM. The camera CPU 116 also controls the focusing and exposure in accordance with element data received from a solid state imaging element provided on the second camera back. (see FIG. 8)

The switch section 117 is manipulated or operated from outside to output various command to the camera CPU 116. The switch section 117b includes a switch S1, a switch S2, a switch SMAIN, a switch SRC, a switch SUS and a switch SISO.

The switch S1 is a photography preparation switch for commanding, through the camera CPU 116, the light measuring unit 104 to initiate light measuring operation, and the focus detecting section 112 to initiate focus detecting operation.

The switch S2 is a release switch for outputting a command signal to the camera CPU to initiate exposure for photographing or picture taking. Receiving the command signal, the camera CPU 116 determines focusing and proper exposure conditions and outputs signals for activating the shutter section 114 and the diaphragm section 115.

The switch SMAIN is for enabling and stopping the power supply to the various parts of the camera body 1 by way of the camera CPU 116. The switch SRC is for detecting whether the first or second camera back is attached to the camera body 1. The switch SUD is for changing or adjusting (increasing or decreasing) the various parameters of photographic conditions for the camera body 1 including shutter speed, diaphragm aperture, ISO sensitivity and so on. The switch SIS is for setting whether the sensitivity value set on the camera body 1 is changed or not.

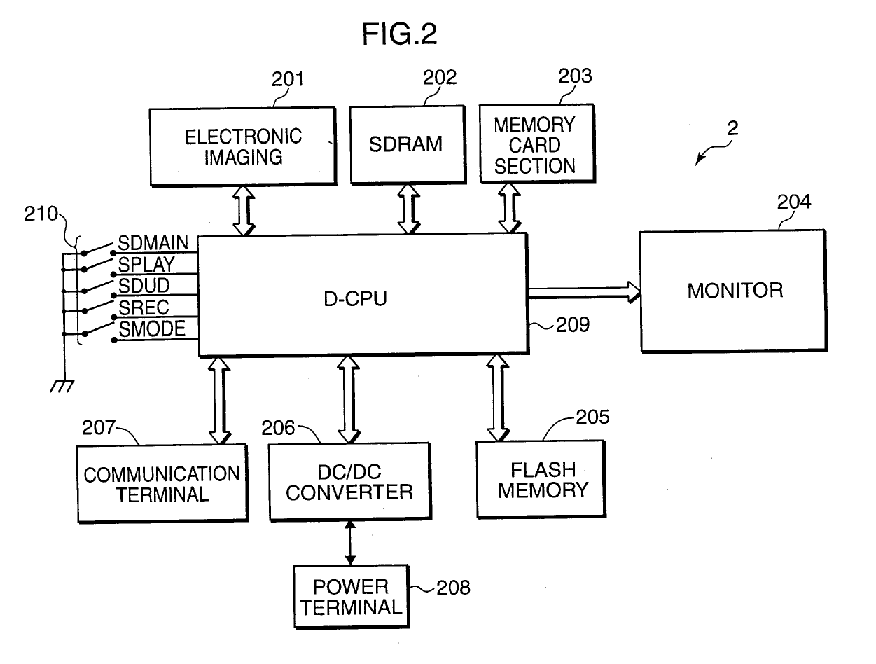

FIG. 2 is a block diagram showing main components of an exemplary camera back provided with a solid state electronic imaging element and is to be coupled with the camera body 1 for digital photography. The camera back of that type is referred to as a second camera back 2 through out the specification. The second camera back 2 comprises an electronic imaging section 201 for producing digital image data from light rays received from the object to be photographed through the objective lens, SDRAM 202 for storing the image data and other related data, a memory card section 203 for storing the image data and related data, and a monitor for displaying the image or picture due to the image data and information of other data. The second camera back 2 is further provided with a flash memory 205 for storing a program for operating D-CPU 209, communication terminals 207 used for transmission of data and signals, a power terminal 208 for supply of electric power, a D-CPU 209 for the control of various parts and units of the second camera back 2, and a switch section 210 to be manipulated or operated by the user.

The electronic imaging section 201 is provided with a solid state imaging element such as a CCD. When coupled with the camera body, the electronic imaging section 201 photoelectrically converts the image of the object formed by the camera objective lens 106, into digital image data and outputs the image data to the D-CPU 209.

SDRAM 202 is a conventional SDRAM (Synchronous Dynamic RAM) and used for storing the image data produced by the electronic imaging section 201 and other data related to the image data. The memory card section 203 includes a memory card which is detachably mounted on the second camera back and which may be composed of a compact type flash memory, or smart media. The memory card has a capacity for storing image data of the images of a plurality of frames produced by the electronic imaging section 201.

The monitor 204 includes a LCD (Liquid Crystal Display) for displaying images due to the image data stored in the SDRAM 202 or memory card 203. The flash memory 205 is a repeatedly rewritable memory for storing a program for operating D-CPU 209 and data including data of the size of the CCD and size of each pixel of the CCD.

In the present embodiment, data as shown in the following Table 1 are stored in the flash memory 205 for a first example of the second camera back with a A-Type of CCD.

F number Range: Minimum F5.6 Maximum F22
Shutter Speed Range: Longest Exposure 4 sec.,
Shortest 1/8000 sec.
ISO Sensitivity Range: Minimum 100, Maximum 800
Data Capturing Speed: 200 ms
Data Processing Speed: 50 ms
Number of Pixels of CCD: 3 Million
CCD Size: ⅓ inches

Another the flash memory 205 for another example of the second camera back 2 with B-type CCD may store data as shown in the following Table 2.

F number Range: Minimum F4.5 Maximum F22
Shutter Speed Range: Longest Exposure 8 sec.,
Shortest 1/8000 sec.
ISO Sensitivity Range: Minimum 200, Maximum 800
Data Capturing Speed: 200 ms
Data Processing Speed: 30 ms
Number of Pixels of CCD: 3 Million
CCD Size: ⅔ inches

The data of the CCDs of the A-type and B-type are different in the minimum diaphragm F value, longest exposure time, minimum ISO sensitivity, data processing speed, and CCD size. As those CCDs have the same number of pixels but are different in CCD size, the size of each pixel is larger in B-type CCD than A-type CCD. Accordingly, the minimum F value is smaller in the case the B-type CCD than in the case of A-type CCD. The longest exposure time is shorter in case of A-type CCD than in the case of the B-type since the A-type CCD with the smaller pixels will be affected more by the noise or dark current. The ISO sensitivity depends on the capacity of the amplifier (SN capacity) which is determined by the process of producing the CCD.

The data capturing speed depends on the clock frequency for the output or capturing of the pixel data of the CCD, and the speed will be lower as the number of the pixels increases. As the A-type CCD and B-type CCD of which data are shown in the Tables 1 and 2, respectively have the same pixel number, and their data capturing speeds depend on the frequency of the clock used for them. The speed for compressing the captured data depends on the digital signal processing speed of the D-CPU 209. The cycle of the successive photography depends on the sum of the time for capturing data and time for compressing the captured data.

DC/DC converter 206 converts the electric power supplied from the battery 101 of the camera body 1 through the power terminal, to a predetermined level of voltage and supplies the electric power of the converted voltage to various parts and units of the second camera back 2.

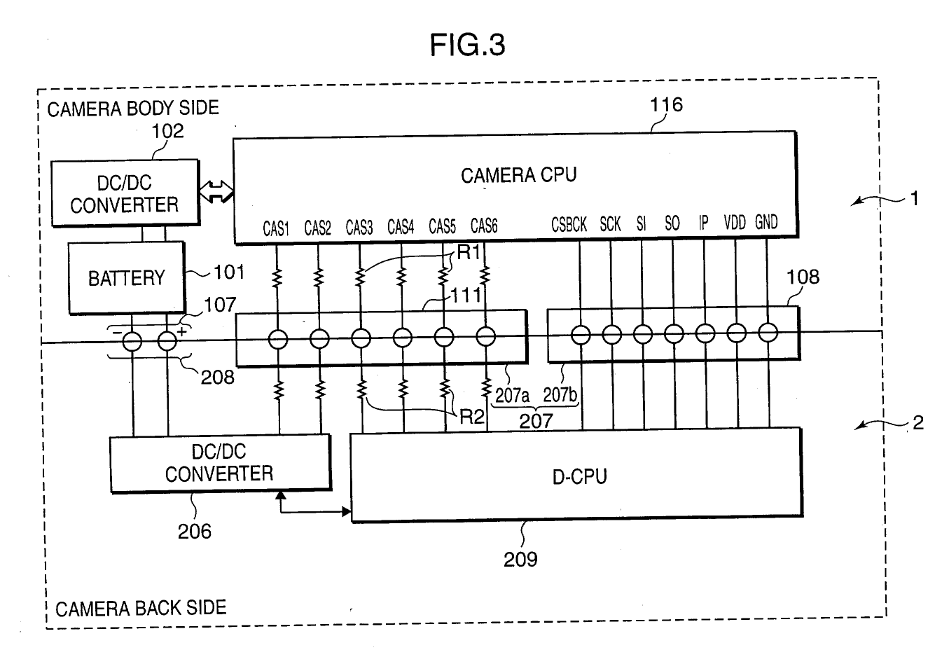

The communication terminals 207 are connected with DX terminals 111 and adjustment terminals 108 of the camera body 1 and are used for communication between the camera body 1 and the D-CPU 209. The communication terminals 207 include communication terminals 207a to be connected with the DX terminals 111 and communication terminals 207b to be connected with the adjustment terminals 108. (see FIG. 3)

The power terminal 208 is to be connected with the power terminal 107 of the camera body 1 and used for supply of electric power from the battery 101 of the camera body 1 to the DC/DC converter 206.

D-CPU 209 outputs various data of the second camera back 2 such as data of the imaging element i.e. the CCD in the present embodiment, through the communication terminals 207, in accordance with the program stored in the flash memory 205. The D-CPU 209 also controls various parts and units of the second camera back 2, receiving photography control signals from the camera body 1 or in response to the operation on the switch section 210. In more detail, the D-CPU 209 controls the image data producing operation by the electronic imaging section 201, operation of transmission of image data from the electronic imaging section 201 to the SDRAM 202 and the memory card section 203, operation of transferring of the image data from the SDRAM 202 and the memory card section 203 to the monitor 204, and the operation of the monitor 204 for displaying the image due to the image data.

The switch section 210 is to make various commands to the D-CPU 209 in response to the operation on the switch section 210 from the user. The switch section 210 of the present embodiment includes a switch SDMAIN, a switch SPLAY, a switch SDUD, a switch SREC and a switch SMODE.

The switch SDMAIN is for the control, through the D-CPU 209, of effecting and stopping power supply from DC/DC converter to various parts and units of the second camera back.

The switch SDUD is for changing (increasing or decreasing), through the D-CPU 209, various set values such as the frame number of the image data stored in the SDRAM 202 or the memory card 203.

The switch SPLAY is for selecting, through the D-CPU 209, whether to display or not the image data stored in the SDRAM 202 or the memory card 203.

The switch SREC is for selecting, through the D-CPU 209, whether to transmit the image data from the electronic imaging section 201 to the SDRAM 202 or the memory card 203. When a picture is taken, the switch SREC is set to enable the image data transmission. (This state is referred to as REC mode)

The switch SMODE is for selecting, through the D-CPU 209, the items to be changed for the changing (increasing or decreasing) of various set values such as the frame number of the image data stored in the SDRAM 202 or the memory card 203. That is, the switch SMODE selects the item or parameter to be changed and the switch SDUD increases or decreases the value of the selected item or parameter.

FIG. 3 shows electric connection between the camera body 1 and the second camera back 2 for the digital photography. In FIG. 3, the up side portion shows the components of the camera body 1 and down side portion shows component of the second camera back 2. When the second camera back 2 is attached to the camera body 1, the power terminals 107 of the camera body 1 are connected with the power terminals 208 of the second camera back 2, and the DX terminals 111 and adjustment terminals 108 of the camera body 1 are connected with the communication terminals 207 of the second camera back 2.

The power terminals 107 of the camera body 1 and the power terminals 208 of the second camera back 2 are respectively provided with a pair of terminals for plus and minus terminals. The electric power of the battery 101 in the camera body 1 is supplied to the DC/DC converter 206 of the second camera back 2 through the power terminals 107 of the camera body 1 and the power terminals 208 of the second camera back 2.

The DX terminals 111 of the camera body 1 are, in the present embodiment, composed of six terminals CAS 1 through CAS 6, and are connected to the CPU 116 of the camera body 1 respectively through resistors R1. The adjustment terminals 108 are, in the present embodiment, composed of seven terminals of CSBCK terminal, SCK terminal, SI terminal, SO terminal, IP terminal, VDD terminal and GND terminal, and connected to the CPU 116 of the camera body 1. Of the communication terminals 207 of the second camera back 2, six communications terminal 207a are connected with the DX terminals 111 of the camera body 1, while the seven terminals 207b are connected with the adjustment terminals 108 of the camera body 1. The six communication terminal 207a are connected to D-CPU 209 and DC/DC converter 206 respectively through resistors R2.

Thus, through the DX terminals 111 and the communication terminals 207a, data transmission channels or paths are formed between the camera CPU 116 and D-CPU 209a. In the same way, through the adjustment terminals 108 and communication terminals 207b, data transmission channels or paths are formed between the camera CPU 116 and D-CPU 209a. Data of photographic conditions including data of shutter speed described later, are transmitted from the camera body 1 to the second camera back 2 through those channels or paths.

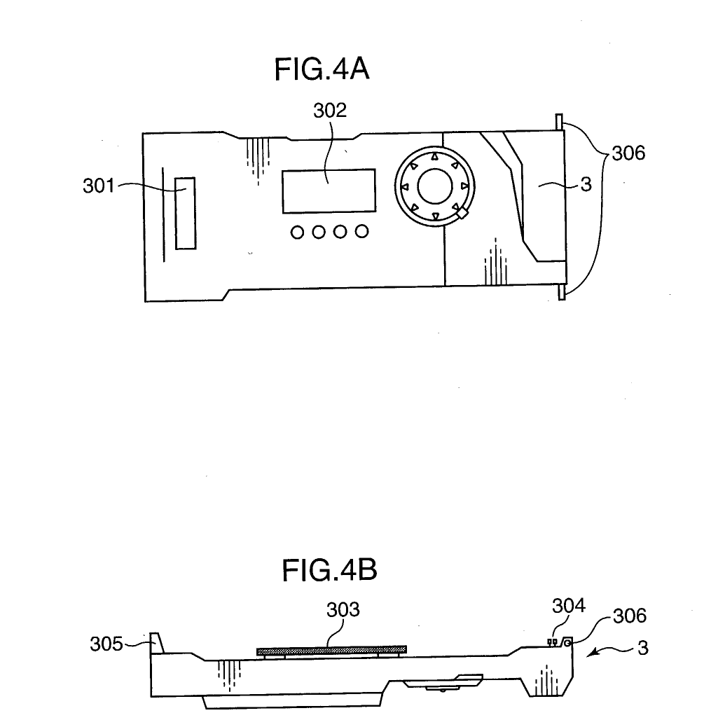

FIG. 4 illustrates structure of the first camera back 3 attached to the camera body 1 to cover the rear of the camera body for photography with a silver haloid film. The camera back 3 is referred to as a first camera back through the specification. FIG. 4A is a front elevation and FIG. 4B is a top view of the first camera back 3. On the left side of the first camera back 3 is formed a film confirming window 301 to enable the user to confirm whether a film cartridge is held in the camera body. At approximately central portion of the first camera back 3 is provided a display 302 composed of a LCD or other display device for displaying various data and information relating to photography.

Inside of the first camera body 3 at its approximately central portion is provided is a film pressure plate 303 for pressing the film to keep the film on the focal plane, allowing the film to move sideway or transversely across the focal plane. On the right side of the first camera back 3 are provided communication terminals 304 for data communication between the CPU 116 of the camera body 1 and the first camera back. At left side end of the first camera back 3 is formed a projection 305 for operating the switch SCR of the camera body 1 when the first camera back 3 is closed on the camera body 1. The projection also has a semi-lock function to retain the first camera back 3 at its closed position.

Pin-shaped projections 306 are provided at up and down portion at right side end of the first camera back 3 to be inserted in corresponding holes (not shown) of the camera body 1 to couple the first camera back 3 to the camera body 1. When coupled to the camera body 1 through the projections 306, the first camera back 3 is hinged to the camera body 1 to open and close the rear of the camera body 1. The pin-shaped projections 306 are respectively urged by springs (not shown) in their projecting directions.

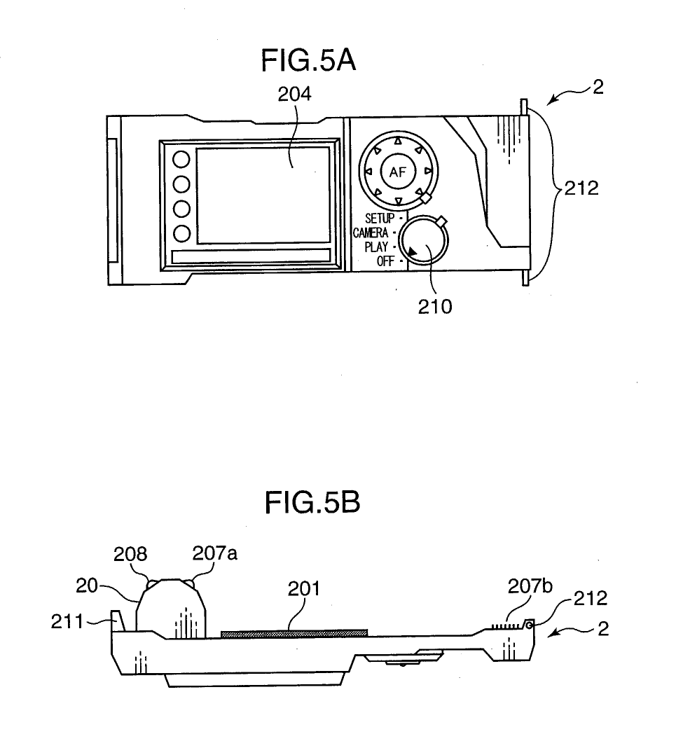

FIG. 5 shows exemplary structure of the second camera back 2 which is to be coupled with the camera body 1 to cover the latter instead of the first camera back 3. FIG. 5A is a front elevation and FIG. 5B is a top plane view. A monitor 204 is provided at approximately central portion, and switches 210 are provided on the right side of the monitor 204. (see FIG. 2)

The electronic imaging section 201 is provided at approximately central portion of the camera back 2, and the communication terminals 207b are provided on the right of the second camera back 2 at the positions corresponding to the positions of the adjustment terminals 108 of the camera body 1. At the left side of the second camera back 2 is formed a protrude portion having the shape which is substantially the same as the shape of the film cartridge. The power terminals 208 and the communication terminals 207a are provided on the surface of the protrude portion at the positions corresponding to the positions of the power terminals 107 and DX terminals 111 of the camera body 1. On the left side end of the second camera back 2 is formed a projection 211 for operating the switch SRC of the camera body 1. The projection 211 also has a semi-lock function to retain the first camera back 3 at its closed position.

The pin-shaped projections 212 are provided at up and down portion at right side end of the second camera back 2 to be inserted in corresponding holes (not shown) of the camera body 1 to couple the second camera back 2 to the camera body 1. When coupled to the camera body 1 through the projections 212, the second camera back 2 is hinged to the camera body to open and close the rear of the camera body 1. The pin-shaped projections are respectively urged by springs (not shown) in their projecting directions.

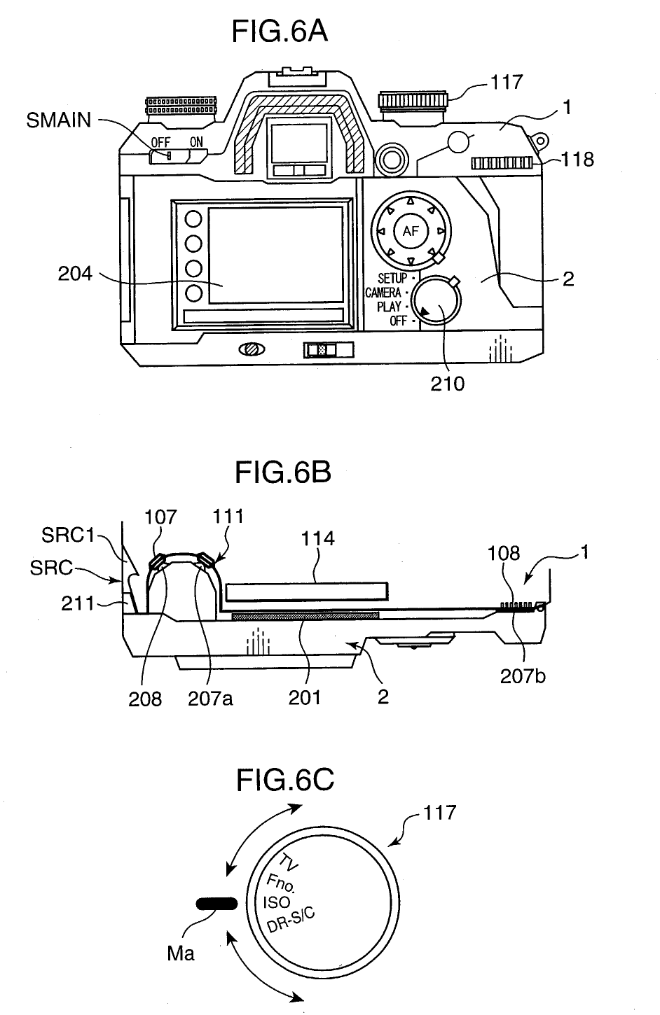

FIG. 6 shows the construction of the state where the second camera back 2 is coupled to the camera body 1. FIG. 6A is a back elevation of the camera body coupled with the second camera back 2, FIG. 6B is a partially sectional top view, of the same and FIG. 6C is a top view of a dial type switch operator.

The switch SMAIN of the slide type is provided on the left top potion of the camera body 1. The shutter section 114 is provided at approximately central portion on the back of the camera body 1, with the electronic imaging section 201 opposing the shutter section 114. The adjustment terminals 108 is provided on the right side of the camera body 1, with the communication terminals 207b respectively being in contact with corresponding adjustment terminals 108. The DX terminals 111 and the power terminals 107 are provided on the left side of the camera body 1 to be exposed to the film cartridge chamber of the camera body 1, with the communication terminals 207a and the power terminals 208 of the second camera back 2 respectively being in contact with corresponding DX terminals 111 and the power terminals 107. The switch SRC is provided on the left side of the camera body 1 to be operated by the projection 305 of the first camera back 3 or the projection 211 of the second camera back 2 such that the movable contact SRC1 is displaced to inform the camera CPU that the camera back. 2 or 3 is closed. In other word, the state of the switch SRC is transmitted to the camera CPU 116 which determine whether the camera back 2 or 3 is closed or not. The switch SRC may not necessary be the mechanical switch as shown in the Figure, but may be other type, such as a one electrically or photoelectrically responsive to the approach of the projection 305 or 211.

The parameter selection dial 117 associated with a photographic parameter selection switch is provided on the right top of the camera body 1 to be turned by the user. On the top of the parameter selection dial 117 are indicated parameters of TV for shutter speed setting, F No. for diaphragm value setting, ISO for the setting of the ISO sensitivity of the electronic imaging element, and DR-S/C for the setting of drive mode, e.g. switching between a single shot and successive shots. When any of the parameter indications is registered with the mark Ma formed on the camera body 1, the registered parameter can be changed. On the right side of the back portion of the camera body 1 is provided a adjusting dial 118 interconnected with a photographic condition increasing/decreasing switch. When the adjusting dial 118 is turned to the left or right, the photographic parameter selected by the parameter selection dial 117 is increased or decreased by a predetermined unit. When the DR-S/C is selected, the single shot or successive shots is selected.

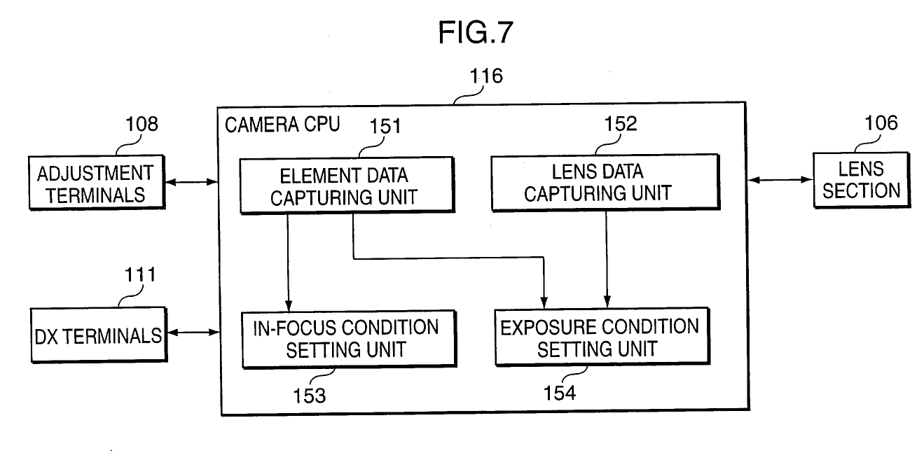

FIG. 7 shows main functional blocks of the camera CPU 116 provided in the camera body 1. The camera CPU 116 comprises an element data capturing unit 151 for capturing data of the electronic imaging device 201, a lens data capturing unit 152 for capturing data of the lens, an in-focus condition setting unit 153 for setting the condition of in-focus, and an exposure condition setting unit 154 for setting photographic conditions.

The element data capturing unit 151 captures data relating to the electronic imaging section 201 of the second camera back 2 including data of the size of the CCD and pixel size (size of one pixel) of the CCD of the electronic imaging section 201, fed from the D-CPU 209 of the second camera back 2 through the DX terminals 111 and the communication terminals 207a. The lens data capturing unit 152 captures lens data including data of focal length of the objective lens, from the lens section 106.

The in-focus condition setting unit 153 is for setting the width or tolerance of in-focus range for the determination of in-focus condition of the objective lens. The width of the in-focus range is determined by the in-focus condition setting unit 153 in accordance with the data of the electronic imaging section 201 obtained by the element data capturing unit 151.

The setting of the width or dimention of the in-focus range by the in-focus condition setting unit 153 will be explained in more detail here. It is common that the digital image taken by the CCD is observed by displaying the image on a screen of a personal computer. In such a case, image is usually enlarged to adapt to the size of the screen of the personal computer, or the size desired by the user. When the image is enlarged, the image originally taken by the CCD which is smaller than one frame of silver haloid film, looks like not-sharply in-focused or out-of focus so that severe focusing is required to the original image. According, it is preferable that the in-focus condition is more severely determined in the case of the image taken by the CCD using the second camera back 2, than in the case of the image taken by the silver haloid film using the first camera back 3. The determination of the in-focus condition is made by judging whether a focused point or position is within a allowable range or tolerance which is referred to as the in-focus range. When the in-focus condition is to be determined severely, the in-focus range is set small. Accordingly, the in-focus condition setting unit 153 sets the in-focus range smaller when the second camera back 2 is attached to the camera body 1 than when the first camera back 3 is attached to the camera body 1.

Further, various sizes of CCDs may be used for the second camera back 2. As the size of the CCD is smaller, or as the size of the pixel of the CCD is smaller, the ratio of magnification or enlargement from the original to the displayed image will be larger, so that the in-focus condition should be determined more severely in the case of the small size CCD or CCD pixel. Accordingly, the in-focus condition setting unit 153 set small in-focus range when a small size or small pixel size CCD is provided on the second camera back 2.

The exposure condition setting unit 154 sets exposure conditions, e.g. the shutter speed and the diaphragm aperture by using a program chart, in accordance with the data of the CCD captured by the element data capturing section 151 and the data of the objective lens captured by the lens data capturing unit 152.

Here, explanation will be made in more detail about the manner of determining the diaphragm aperture value by the exposure condition setting unit 154. The range of available aperture values is smaller when a picture is taken by the CCD with the second camera back 2 being attached to the camera body 1, than when a picture is taken by the silver haloid film with the first camera back 3 being attached to the camera body 1. This is because the size of the CCD is generally smaller in size than the one frame of a silver haloid film. Accordingly, it is necessary to restrict the range of the diaphragm aperture value in accordance with the size of CCD. In addition, a picture taken by the CCD shows significant lowering of marginal lumination as compared with the case when a picture is taken by a silver haloid film. Thus, when a picture is taken by the CCD with the second camera back 2 being attached to the camera body 1, the quality of the picture image will be improved as the diaphragm aperture value is set to a smaller aperture to increase the aperture efficiency relatively. Thus, the exposure condition setting unit 154 sets an aperture value within a range determined in accordance with the size of the CCD and sets relatively smaller diaphragm aperture when a picture is taken by the CCD with the second camera back 2 being attached to the camera body 1.

In addition, as the focal length is longer, the image circle for maintaining the luminance required for the photography (marginal lumination) and the quality of the image, will be relatively larger so that shutter speed priority automatic exposure is available and that the quality of the image will be improved as the diaphragm aperture is set to a value close to or at full aperture. Accordingly, the exposure condition setting unit 154 set the diaphragm aperture closer to the full aperture as the focal length of the objective lens is larger.

Referring to FIGS. 8 through 16 the operation of the camera body 1 will then be explained for the case where the second camera back 2 is attached to the camera body 1. FIG. 8 is a flowchart roughly showing an exemplary operation of the camera body 1. The operation as will be explained herein after is processed by the camera CPU 116. It is to be understood that the camera body 1 i.e. the camera CPU 116 may communicate with the second camera back 2 i.e. the d-CPU 209 through DX terminals 111, adjustment terminals 108 and the communication terminals 207.

First, it is determined whether the switch S1 has been turned on, i.e. whether a command for initiating the light measurement and focus detection has been made. (Step #1) When it is determined that the switch S1 has not been turned on (No at step #1), the flow returns back to the step #1 to wait until the switch S1 is turned on. When it is determined that the switch S1 has been turned on (Yes at step #1), the state of the switch SREC of the second camera back 2 is read in and it is determined whether the switch SREC has been turned on or not, i.e. whether REC mode has been set with the second camera back 2 being ready for the photography. (Step #3)

When it is determined that the switch SREC has not been turned on, (No at Step #3), the flow returns to Step #1. When it is determined that the switch SREC has been turned on, (Yes at Step #3), the lens data capturing unit 152 captures lens data including the focal length of the camera objective lens, from the lens section 106. (Step #5) Then, the element data capturing unit 151 captures, from D-CPU 209, data of the solid state imaging element, e.g. the CCD, including the size and pixel size of the CCD, stored in the flash memory 205 of the second camera back 2. (Step #7)

Then, a light measurement command signal is outputted to the light measuring unit 104 so that the light measuring unit 104 execute light measuring operation and the measured value or measurement is obtained. (Step #9) Next, focus detection command signal is outputted to the focus detecting section 112 which, in turn, executes focus detection to obtain a data of detected focus condition. In accordance with the detected focus condition, AF (Automatic Focusing) command signal is outputted to the AF motor driving section 113. (Step #11) It is then determined whether the switch S2 has been turned on to output exposure initiation command signal, or not. (Step #13)

When it is determined that the switch S2 has not been turned on, (No at Step #13), the flow turns back to Step #1. When it is determined that the switch S2 has been turned on, the battery 101 is checked. (Step #15) When the voltage of the battery 101 is lower than a predetermined value, it is determined that the photographic operation is impossible until the battery is exchanged, and the flow proceeds to standing-by state. When the voltage of the battery is not lower than the predetermined value, the reflex mirror is turned up to retire from the photographic optical path to allow the light from an object to be photographed to impinge on the focal plane, thereby preparing for exposure operation. (Step #17) Then, a diaphragm aperture value and shutter speed is determined and command signal for the exposure operation is outputted to make the diaphragm section 115 and shutter section 114 execute exposure operation. (Step #19) After that, a command signal is outputted to the electronic imaging section 201 to transfer the image data taken by the electronic imaging section 201. (Step #21)

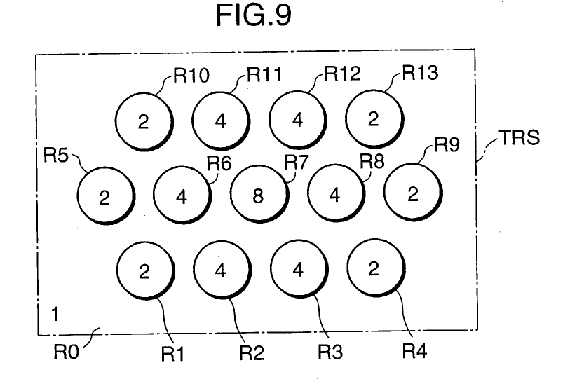

Referring to FIGS. 9 through 11, explanation will be made in more detail about the light measuring operation made at Step #9 in FIG. 8. FIG. 9 shows an exemplary arrangement of the light measuring areas by means of the light measuring unit 104 when the first camera back 3 is coupled to the camera body 1. As shown in FIG. 9, within the entire picture taking area corresponding to the area of one frame of a silver haloid film, such as of 35 mm type, thirteen light measuring areas R1 through R13 (referred to as divided light measuring areas) are arranged in three lines with upper and lower lines respectively including four areas while the middle line including five areas which are shifted by 1/2 pitch from the areas of the upper and lower lines. Also the entire light measuring area RO covering the entire frame area TRS is treated as a light measuring area. In the embodiment, photoelectric elements such as photo-diodes are arranged to measure the light at respective light measuring area. In addition, the light measuring areas are weighted respectively as indicated by the numerals in the circles showing the light measuring areas. For example, the weight of the central light measuring area R7 is “8” while the weight of the entire light measuring area is “1.” A proper exposure value is determined by multiplying the values measured by respective photoelectric elements, by the weight values assigned to respective light measuring areas.

When the first camera back 3 is attached to the camera body 1, the size of picture taking area corresponding to one frame of the silver haloid film is constant, and predetermined values are always used for the weight values assigned to respective light measuring areas. However, when the second camera back 2 is attached to the camera body 1, the picture taking area varies with the size of the CCD and it is necessary to change the weights in accordance with the size of CCD.

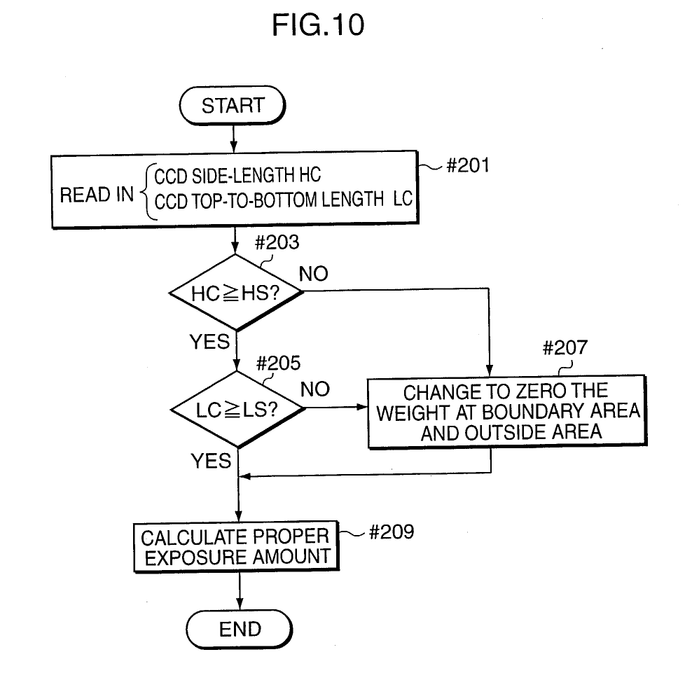

FIG. 10 is a flowchart showing an exemplary light measuring operation made at Step #9 in FIG. 8. It is assumed here that the light measuring area is set at a given size and divided into a predetermined numbers of areas. Also it is assumed that predetermined weights are assigned to respective divided areas for the determination of a proper exposure value.

First, the data of the sizes of the CCD provided on the second camera back 2 attached to the camera body 1 is read in. (Step #201) The size of the CCD includes the length HC from side end to other side end (referred to as side length) and the length LC from its top to bottom (referred to as top-to-bottom length). It is then determined whether the side length HC of the CCD is equal to or larger than a predetermined side length HS of the photographic area. (Step #203) When it is determined that the side length HC of the CCD is not equal to nor larger than the side length HS of the photographic area, (No at Step #203), the flow proceeds to Step #207. When it is determined that the side length HC of the CCD is equal to or larger than a predetermined side length HS photographic area, (Yes at Step #203), it is then determined whether the top-to-bottom length LC of the CCD is equal to or larger than a predetermined top-to-bottom length LS of the photographic area. (Step #205) When it is determined that the top-to-bottom length LC of the CCD is equal to or larger than a predetermined top-to-bottom length LS of the photographic area, (Yes at Step #205), the flow proceeds to Step #209. When it is determined that the top-to-bottom length LC of the CCD is not equal to nor larger than a predetermined top-to-bottom length LS of the photographic area, (No at Step #205), the flow proceeds to Step #207.

When it is determined as No at Step #203 or No at step #205, i.e. when at least a part of the light measuring area is outside of the photographic area, the weight is set at zero for the divided areas residing in the outside of the photographic area. (Step #207) Then, a proper exposure value will be obtained by multiplying the light measurements of respective divided light measuring areas by the weights of the divided areas. (Step #209)

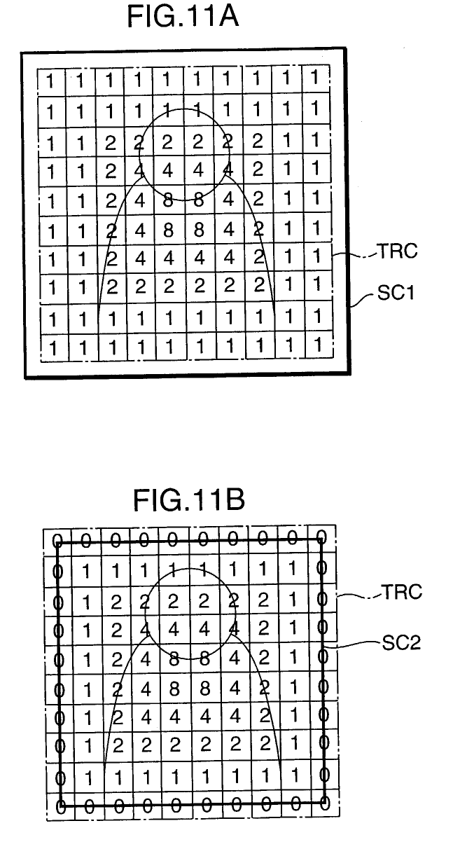

FIG. 11 shows an exemplary arrangement of light measuring areas at the light measuring unit 104 when the second camera back 2 is attached to the camera body 1. FIG. 11A shows a case where the light measuring area TRC is within the photographic area SC1, i.e. when the CCD is larger in size than a predetermined size. FIG. 11B shows a case when a part of the light measuring area TRC is outside of the photographic area LC2, i.e. when the size of the CCD is smaller than the predetermined size. In the Figure, grid lines show boundary lines for dividing the light measuring area to a predetermined number of areas. The numerals in the divided areas designates the weights assigned to the divided areas. In the embodiment shown in the Figure, the light measuring area TRC is divided into 100 areas, i.e. ten for each line and row.

As shown in FIG. 11A, when the light measuring area TRC is within the photographic area SC1, predetermined weight values are used for the calculation of a proper exposure value. When a part of the light measuring area TRC is outside of the photographic area LC2 as shown in FIG. 11B, the weight values of at least the divided light measuring areas outside of the photographic area are changed to zero, and the proper exposure value is calculated with the changed weight values.

In the embodiment described above, the weight values are changed in accordance with the size of the CCD. Instead, both the weight values and light measuring area may be determined in accordance with the size of the CCD. For example, the data of the weight values and light measuring area may be stored in a look-up table in connection with every possible sizes of CCD and the light measuring area may be set in accordance with the size of the CCD read in at Step #7. In that case, the exposure will be controlled more properly.

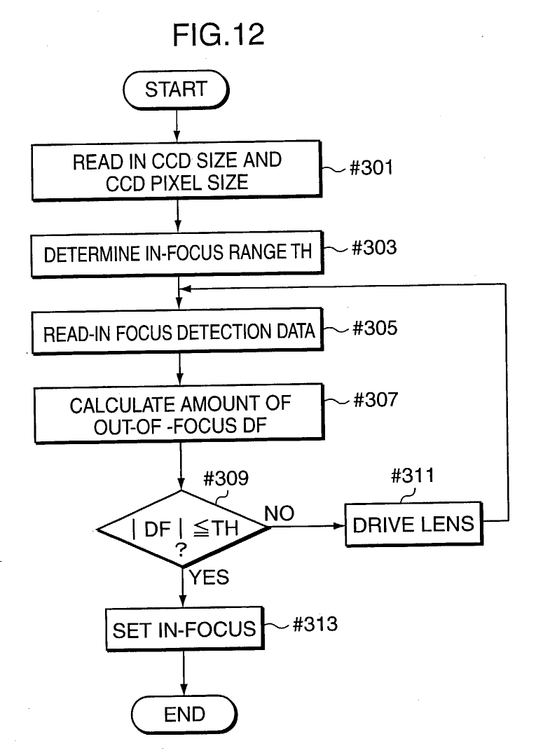

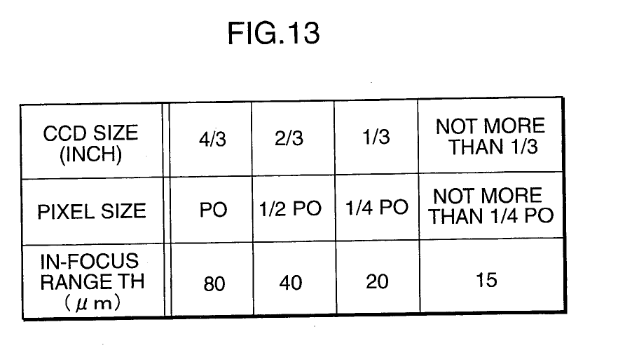

Referring to FIGS. 12 and 13, explanation will be made about the AF (Automatic Focusing) operation executed at Step #11. FIG. 12 is a flowchart showing in more detail the AF operation executed at Sep #11. The in-focus condition setting unit 153 read in data of the CCD size and Pixel size of the CCD mounted on the second camera back 2. (Step #301) Then, the in-focus condition setting unit 153 determines an in-focus range TH for the judgment of in-focus, in accordance with the data of the size of the CCD and the size of a pixel of the CCD. (Step #303) To this end, the EEPROM 102 stores a look-up table showing the relationship between the size of the CCD and the size of a pixel of the CCD and the in-focus range TH such as shown in FIG. 13, and the in-focus range TH is obtained from the look-up table with reference to the size of the CCD and the size of a pixel of the CCD read-in by the in-focus condition setting unit 153.

FIG. 13 shows an example of a table showing the relationship between the size of the CCD and the size of a pixel of the CCD and the in-focus range TH. The first line of the table shows the sizes of CCDs by inch, with the figures showing the diagonal lengths of the picture-taking areas of CCDs. The second line shows the sizes of pixels of CCDs in terms of the ratio with a standard size P0. In other words, the second line shows what times as much as the standard size, the size of the pixel of each CCD is. The standard size is such a size of each of 5 million pixels of a CCD of 4/3 inch, and each pixel is square in shape with the length of each side being approximately 10 micron (μm). The third line shows the in-focus range TH by the unit of micron (μm).

For example, when the size of a CCD is 4/3 inch and the size of the pixel of the CCD is P0, the in-focus range is set at 80 m. When the size of a CCD is 1/3 inch and the size of the pixel of the CCD is 1/4 P0, the in-focus range is set at 20 μm. In the case of picture taking with a silver haloid film, the in-focus range is 100 μm.

That is, a smaller in-focus range is set in the case of picture-taking with a CCD than in the case of picture-taking with a silver haloid film. In addition, the smaller the size of CCD is or the smaller the size of the pixel of the CCD is, the smaller or shorter the set in-focus range will be.

In this way, the in-focus range TH is obtained at Step #303 of the flowchart shown in FIG. 12, using the look-up table defining the relationship between the in-focus range and the data of the size of the CCD and the size of a pixel of the CCD. Although the present embodiment uses the look-up table for the determination of the in-focus range TH, instead, the in-focus range TH may be calculated according to a preset equation from the size of the CCD and the size of a pixel of the CCD.

Returning back to the flowchart shown in FIG. 12, focus detection command signal is outputted to the focus detecting section 112 and focus condition is detected. (Step #305) From the detected focus condition, an amount of out-of-focus DF is calculated. (Step #307) Then, it is determined whether the absolute value of the calculated amount of out-of-focus DF is larger or not larger than the in-focus range. (Step #309)

When it is determined that the calculated amount of out-of-focus DF is larger than the in-focus range TH, (No at Step #309), an amount of lens driving corresponding to the amount of out-of-focus DF, is calculated and a lens driving command signal is outputted to the AF motor driving section 113 (Step #311), and the flow returns to Step #305. When it is determined that the calculated amount of the out-of-focus DF is not larger than the in-focus range TH, (Yes at Step #309), a setting of in-focus condition is made to allow shutter release and indicate in-focus condition. (Step #313)

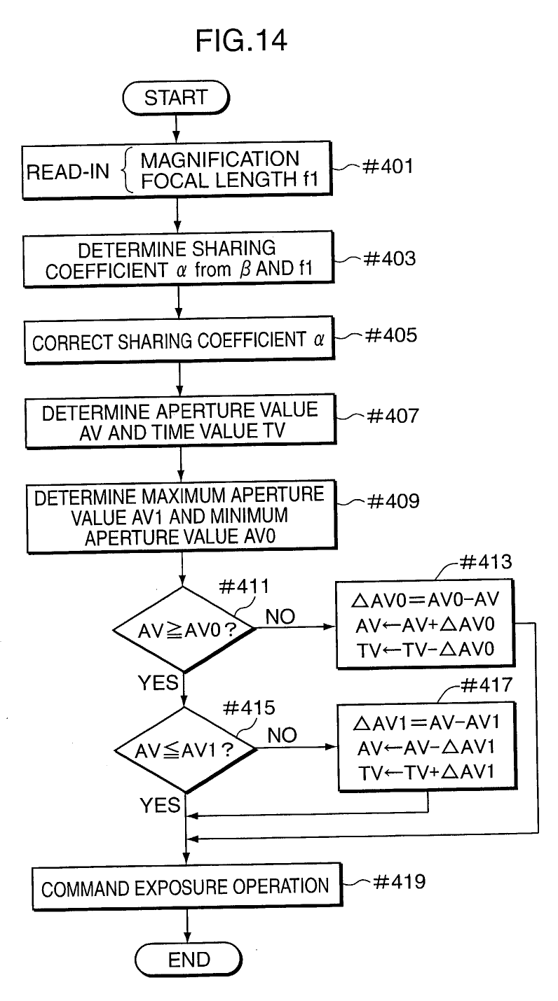

Referring to FIGS. 14 through 16, explanation will be made about the exposure operation executed at Step #19 of FIG. 8. FIG. 14 is a flowchart showing in more detail an example of the exposure operation executed at Step #19 of FIG. 8. It is to be noted that the process described herein after is performed by the exposure condition setting section 154. First, data of image magnification β and the focal length f1 of the camera objective lens are read in. (Step #401) From the image magnification β and the focal length f1 is obtained a sharing coefficient α which is for sharing the proper exposure value EV obtained at Step #9 of FIG. 8, to a time value TV and an aperture value AV. (Step #403) For that sharing, EEPROM 102 stores a look-up table which defines the relationship between the sharing coefficient α and the image magnification β and the focal length f1 to obtain, by means of the look-up table, a sharing coefficient α from the data of the image magnification β and the focal length f1 read by the exposure condition setting unit 154.

The sharing coefficient α will be explained here in more detail. First, explanation is made about the relationship between the proper exposure value EV, and time value TV and aperture value AV for providing a proper exposure represented by the proper exposure value EV. The relationship among the proper exposure value EV, time value TV and aperture value AV is formulated as follows:

EV=TV+AV (1)

The relationship among the proper exposure value EV, a shutter speed T expressed by second, and a diaphragm value A expressed by F number, is expressed by following formula (2):

EV=log₂(A²/T) (2)

The time value TV and the aperture value AV are respectively defined by following formulas (3) and (4) in terms of the shutter speed T and the diaphragm value A.

TV=log₂(1/T) (3)

AV=log₂A² (4)

The formula or equation (1) is obtained from the formulas (2) through (4).

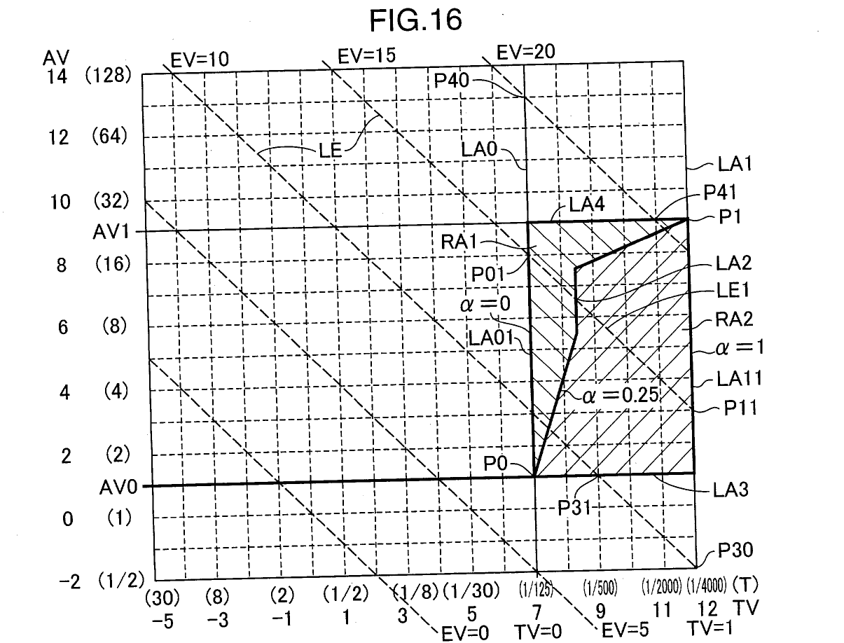

The sharing coefficient α is for defining the conditions for sharing a given proper exposure value EV to the time value TV and the aperture value AV. The sharing coefficient α has a value from 0 to 1. When the value of the sharing coefficient α is relatively large, the time value TV is large (the shutter speed is high) and the aperture value AV is small (the diaphragm aperture is small), and vice versa. The sharing coefficient will be explained in more detail later with reference to FIG. 16.

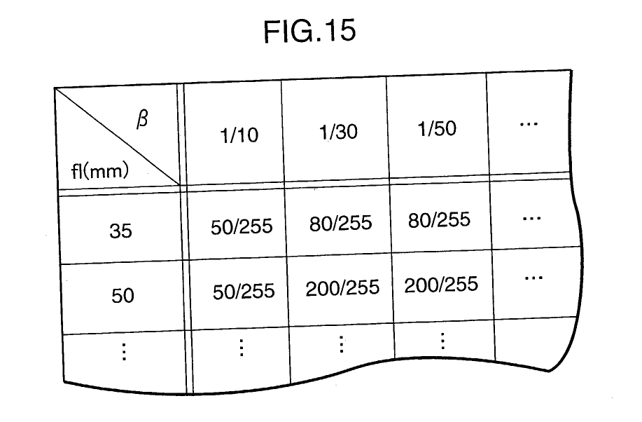

FIG. 15 shows, by for example, a portion of a table showing the relationship between the sharing coefficient α and the image magnification β and the focal length f1 of the camera objective lens. The first line shows the image magnification β, and the first row shows the focal length f1 expressed by millimeter. The numerals or figures in other portions of the table show the sharing coefficients a which are designated by the image magnification α in the first line and the focal length f1 in the first row. For example, when the image magnification β is “1/10” and the focal length f1 is “35 mm”, the sharing coefficient α is “20/255.” When the image magnification β is “1/50” and the focal length f1 is “50 mm”, the sharing coefficient α is “200/255.”

In this way, the sharing coefficient α is obtained at the Step #403 of FIG. 14, by means of a look-up table which, as shown in FIG. 15, defines the relationship between the sharing coefficient α and the image magnification β and the focal length f1.

The image magnification β is interpolated by linear interpolation (interior division) to obtain the sharing coefficient α. Although the present embodiment uses the look-up table for the determination of the sharing coefficient α, instead, the sharing coefficient α may be calculated according to a preset equation from the image magnification β and the focal length f1.

Returning again back to the flowchart shown in FIG. 14, the sharing coefficient α is corrected in accordance with the size of CCD. (Step #405) As described above, the smaller the size of the CCD is, the more the quality of image is improved by setting the aperture value at a value corresponding to a smaller diaphragm aperture. Accordingly, the sharing coefficient α is corrected in the manner that as the size of the CCD is smaller, the sharing coefficient αis smaller i.e. the aperture value will be larger to give a smaller diaphragm aperture size. Next, a time value TV and an aperture value AV are obtained, by means of a program chart shown in FIG. 16, from the proper exposure value EV and the sharing coefficient αobtained at Step #405. (Step #407)

Then, explanation will be made about the manner of calculating the time value TV and the aperture value AV at Step #411, using the program chart shown in FIG. 16. FIG. 16 shows an example of the program chart, with the abscissa representing the time value TV while the ordinate representing the aperture value AV. The values of the shutter speed T and F number respectively corresponding to the time values and aperture values are shown in parentheses along the abscissa and ordinate. The conditions to provide a proper exposure amount EV is shown by a line LE which has a rightward declining slope of “−1.” For example, when the proper exposure value EV is 15, following equation (5) is obtained from the equation (1).

AV=15−TV (5)

The conditions for the sharing coefficient α to be “.zero”, is that the time value is the minimum limit value TV0 (in the example shown, the value is 7) for not causing blurred image due to shaking of the camera body by the hand holding the camera body. This condition is expressed by the following equations (6), and is shown in FIG. 16 by a straight line LA0 which is in parallel with the ordinate. The conditions for the sharing coefficient α to be “1” is that. Time value TV is a value TV1 corresponding to the maximum shutter speed available with the camera. (In the example shown, the value is “12”) with that condition being expressed by the following equations (7), and shown in FIG. 16 by a straight line LA1 which is in parallel with the ordinate.

TV=TV0(=7) (6)

TV=TV1(=12) (7)

The conditions for the sharing coefficient α to be “0.25” is shown in FIG. 16, by a bent line LA2. While the sharing coefficient α is within the range of 0 through 0.25, the line LA2 extends in the area RA1 which is shown by hatching of rightward declining lines, with the line LA2 passing through the points P0 and P1. The point P0 is an intersection of the line LA2 and the line LA0. The point P1 is an intersection of the line LA2 and the line LA1. When the sharing coefficient α is larger than “zero” but smaller than “1”, the program line will be the line LA0 in the area where the aperture value is not larger than the minimum aperture value AV0. The program line will be the line LA1 in the area where the aperture value is larger than the maximum aperture value AV1 as explained later.

Explanation will be made next, about the relationship between the sharing coefficient α and the bent line defined by the sharing coefficient α in the case when the sharing coefficient α is larger than “zero” but smaller than “1.” First, attention should b directed to the segment of the line LA3 defined by the following equation (8) in terms of the minimum aperture value AV0 (“1” in the present embodiment), and the segment of the line LA4 defined by the following equation (9) in terms of the maximum aperture value AV1 (“9” in the present embodiment).

AV=AV0(=1) (provided that TV0≦TV≦TV1) (8)

AV=AV1(=9) (provided that TV0≦TV≦TV1) (9)

Then, consideration is made about the segment of line LA01 which is a portion of the line LA0 and which satisfies the conditions that AV0≦AV≦AV1 in terms of the aperture value, and the about the segment of line LA11 which is a portion of the line LA1 and which satisfies the conditions that AV0≦AV≦AV1 in terms of the aperture value.

Then, consideration is made about the intersection P11 of the line segment LA3 or LA11 and the line LE which is defined by the proper exposure value EV, and the intersection P01 of the line segment LA4 or LA01 and the line LE which is defined by the proper exposure value EV. The bent line defined by the sharing coefficient α is a collection of dots which divide a line segment LE1 extending between the intersections P01 and P11, in a ratio of α:(1−α).

The time value TV and aperture value AV are obtained, in the program chart, as the coordinates of the intersection of the straight line LE defined by the proper exposure value EV and the bent or straight line LA defined by the sharing coefficient. For example, when the proper exposure value EV is “15” and the sharing coefficient α is “0.25”, the time value TV is “8.5” and the aperture value AV is “6.5.”

Returning back again to the flowchart shown in FIG. 14, in accordance with the size of the CCD, the maximum aperture value AV1 which is the maximum value available with the aperture value, and the minimum aperture value AV0 which is the minimum value available with the aperture value, are obtained. (Step 409) The EEPROM 109 stores, in advance, a look-up table for defining the relationship between the size of the CCD and the maximum and minimum aperture values AV1 and AV0, and the maximum and minimum aperture values AV1 and AV0 are obtained by means of the look-up table.

Then it is determined whether the aperture value is equal to or larger than the minimum aperture value AV0. (Step #411) When it is determined that the aperture value is not equal to nor larger than the minimum aperture value AV0, (No at step “411), the aperture value AV and the time value TV are corrected by the amount of correction ΔAV0 defined by following equation (10-1), in accordance with the equations (10-2) and (10-3). (Step #413) Then, a signal for commanding exposure operation including the data of the aperture value AV and time value TV is outputted to the shutter section 114 and the diaphragm section, (Step #415) and the process is terminated.

ΔAV0=AV0−AV (10-1)

AV←AV+ΔAV0 (10-2)

TV←TV−ΔAV0 (10-3)

When it is determined that the aperture value is equal to or larger than the minimum aperture value AV0, (Yes at step “411), the aperture value AV and the time value TV are corrected by the amount of correction ΔAV1 defined by following equation (11-1) in accordance with the equations (11-2) and (11-3). (Step #417) Then, a signal for commanding exposure operation including the data of the aperture value AV and time value TV is outputted to the shutter section 114 and the diaphragm section, (Step #419) and the process is terminated.

ΔAV1=AV−AV1 (11-1)

AV←AV−ΔAV1 (11-2)

TV←TV+ΔAV1 (11-3)

When it is determined that the aperture value AV is not larger than the maximum aperture value AV1, (Yes at Step #415), a signal for commanding exposure operation including the data of the aperture value AV and time value TV is outputted to the shutter section 114 and the diaphragm section, (Step #419) and the process is terminated.

The purpose of correcting the aperture value AV and the time value TV at Steps #413 and #417 in the flowchart shown in FIG. 14, is to make the aperture value AV not smaller than the minimum aperture value AV0 and not larger than the maximum aperture value AV1. For example, when EV=10 and α=1, correction is made for the value at the point P30 to the value at the point P 31. When EV=20 and α=0, correction is made for the value at the point P40 to the value at the point P 41.

As described above, according to the first embodiment of the present invention, the in-focus range TH is obtained in accordance with the size of the CCD and the size of a pixel of the CCD, a proper in-focus range is obtained. The judgment of in-focus condition is made in terms of the proper in-focus range obtained as mentioned above, and accordingly, the judgment of in-focus condition is matched with the size of the CCD and the size of a pixel of the CCD.

In addition, as the weight values for the calculation of a proper exposure value is set in accordance with the size of the CCD, the amount of the proper exposure matches the size of the CCD. Further, as the sharing coefficient α is determined in accordance with the focal length f1 of the camera objective lens and the size of the CCD, and the time value TV and the aperture value AV are determined from the sharing coefficient α and the proper exposure value EV, the time value TV and the aperture value AV match the focal length f1 of the camera objective lens and the size of the CCD. As the time value TV and the aperture value AV are obtained by means of a program chart, the time value TV and the aperture value AV are obtained easily and correctly. The exposure is controlled using the time value TV and the aperture value AV obtained as described above, the controlled exposure matches the focal length f1 of the camera objective lens and the size of the CCD.

The embodiment may be modified as follows;

(A) In the described embodiment, the element data includes both the data of the size of the CCD and the size of a pixel of the CCD. Instead thereof, the element data may include either of the CCD and the size of a pixel of the CCD.

(B) In the described embodiment, both the in-focus condition setting unit 153 and the exposure condition setting unit 154 set or determine the in-focus condition and exposure condition. Instead thereof, at least either one of the in-focus condition setting unit 153 and the exposure condition setting unit 154 may be set or determine the in-focus or exposure conditions in accordance with the data of the electronic imaging element.

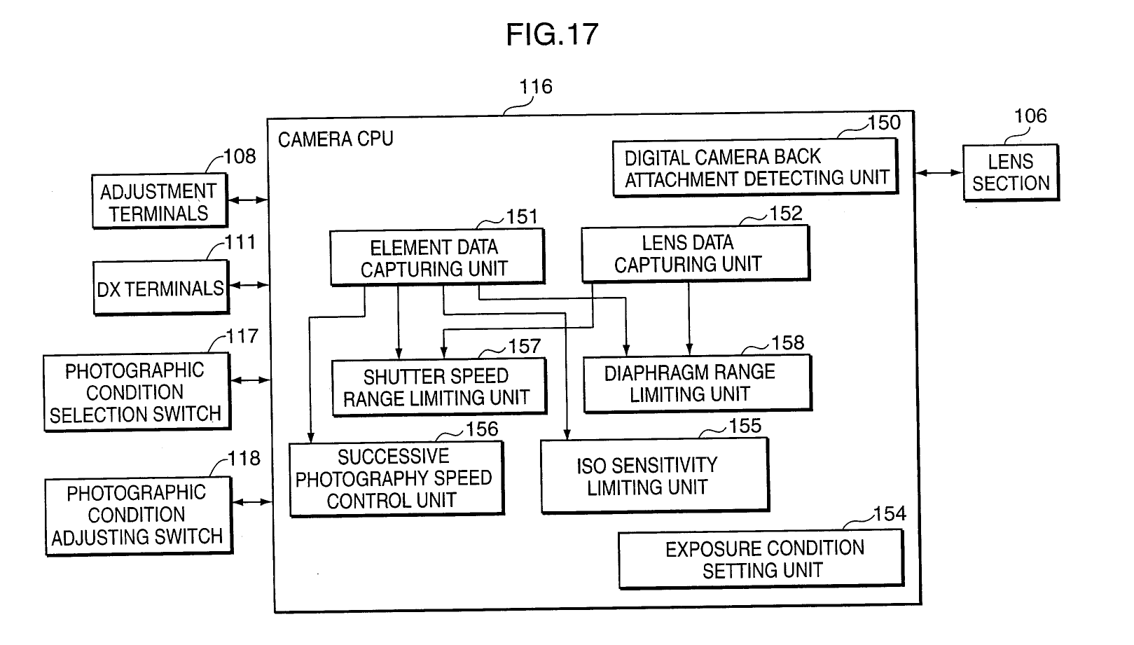

FIGS. 17 through 20 show a second embodiment of the present invention. FIG. 17 is a block diagram showing main functional component of the camera body. In FIG. 17, same reference numerals are used for the components that are substantially the same or similar to the components of the first embodiment. It is to be noted that the main construction of the camera body and camera backs are substantially the same as those of the first embodiment and reference is to be made to the description of the first embodiment with regard to the detailed construction and operation of the common parts.

The camera CPU 116 comprises a second camera back attachment detecting unit 150 for detecting whether the second camera back 2 (digital camera back) is attached to the camera body 1 or not, an element data capturing unit 151 for capturing the data of the electronic imaging including the CCD, a lens data capturing unit 152 for capturing data of the lens section 106, a shutter speed range limiting unit 157 for limiting the range of shutter speed setting, a diaphragm range limiting unit 158 for limiting the range of diaphragm aperture setting, an ISO sensitivity limiting unit 155 for limiting the setting range of ISO sensitivity, a successive photography speed control unit 156 for setting the speed of successive photography, and the exposure condition setting unit 154 The shutter speed range limiting unit 157 composes an exposure condition setting range limiting unit along with the a diaphragm range limiting unit 158 and ISO sensitivity limiting unit 155.

The element data capturing unit 151 captures the data of the electronic imaging unit including the data of the size of CCD and the size of a pixel of the CCD of the imaging unit, from the flash memory 205 of the second camera back 2, via the DX terminals 111 and the communication terminals 207a. The lens data capturing unit 152 captures from the lens section 106 the data of the camera objective lens including the data of its focal length.

The shutter speed range limiting unit 157 limits the range of the shutter speed to be manually set by means of the photographic condition adjusting switch 118 or automatically set in accordance with a light measurement by means of a program chart (stored in the flash memory 205), with the limitation being made as a function of the data of the electronic imaging section 201 captured by the element data capturing unit 151 and the data of the lens section 106 captured by the lens data capturing unit 152.

Explanation will be made in more detail about the limitation of the shutter speed range made by the shutter speed range limiting unit 157. The solid state imaging element such as the CCD, has a characteristics that as the devise is exposed to light for a long time, the device generates noise which deteriorates S/N ratio, with the amount of the noise increasing approximately in proportion to the exposure time. Accordingly, a long exposure time such as 30 second which can be set for the photography with a silver haloid film can not be employed for the photography with the solid state imaging device.

The diaphragm aperture range limiting unit 158 limits the range of the diaphragm aperture to be manually set by means of the photographic condition adjusting switch 118 or automatically set in accordance with a light measurement by means of a program chart (stored in the flash memory 205), with the limitation being made as a function of the data of the electronic imaging section 201 captured by the element data capturing unit 151 and the data of the lens section 106 captured by the lens data capturing unit 152.

Explanation will be made in more detail about the diaphragm aperture range limitation made by the diaphragm aperture range limiting unit 158. As the size of the CCD is smaller than the size of one frame of a silver haloid film, the range of the diaphragm aperture to be set is smaller in the case of picture-taking with the CCD with the second camera back being attached to the camera body, as compared with the case when a picture is taken with a silver haloid film with the first camera back 3 being attached to the camera body 1. Accordingly, it is necessary to set the diaphragm aperture within a range limited in accordance with the size of the CCD. In addition, the picture taken by the CCD shows a significant decrease of marginal lumination in comparison with the case when the picture is taken with the silver haloid film. When a picture is taken with the CCD with the second camera back 2 being attached to the camera body 1, the quality of the image will be improved if the diaphragm aperture is set to a smaller aperture to increase the aperture efficiency. To this end, the diaphragm aperture range limiting unit 158 sets the diaphragm aperture to a small aperture as well as sets the diaphragm aperture value within a range determined in accordance with the size of the CCD.

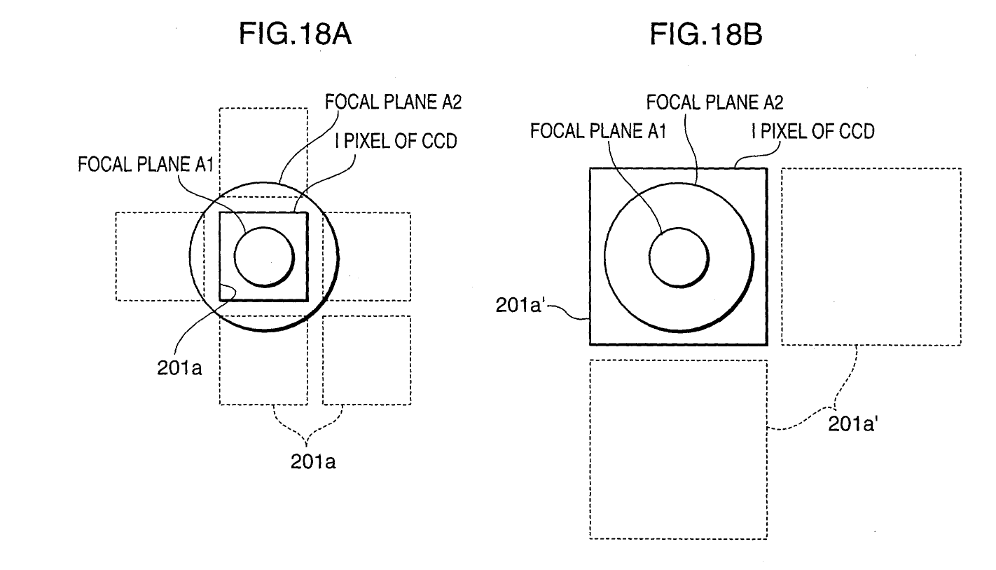

As the focal length of the camera objective lens is larger, the image circle (described later with reference to FIG. 18) for maintaining the illumination for the purpose of picture taking (marginal lumination) and the quality of the image, become relatively larger, shutter-speed priority photography is available, and the quality of the image will be improved as the diaphragm aperture is set to a larger aperture. Accordingly, the diaphragm range limiting unit 154 set larger diaphragm aperture as the focal length of the camera objective lens is larger.

FIG. 18 is for the explanation of the image circle. FIG. 18A show the case where the size of each pixel of the CCD is small, while FIG. 18B shows the case where the size of each pixel of the CCD is large. Generally, in the case of aberration-free lens, an image of a point object passing through the lens does not focus as a point but forms an image of a bright disk or circle surrounded by a concentric ring having a certain brightness (referred to as an image circle), due to the diffraction by the diaphragm. The bright disk image with the surrounding circle is referred to as an Airy disk. If it is assumed that the radius of the disk is r and the wave length of a light λ, their relationship is expressed as r=1.22×(F No.)×(λ). From this equation, it can be said that as the F number (F No.) is smaller, the image quality will be worse. Referring to FIG. 18A, the reference mark Al denotes the image circle formed with the diaphragm being fully open, while A2 denotes the image circle formed with the diaphragm being stopped-down to some extent. The image circle A2 extends over the area of one pixel when the pixel is small so that the image circle A2 is also formed on other pixels. On the other hand, when the size of the pixel is large, even the image circle A2 is within the area of a pixel, so that the diaphragm aperture may be stopped down to a smaller aperture than in the case of the small pixel.

In accordance with the data of the electronic imaging unit captured by the element data capturing unit 152 and the data of the camera objective lens captured by the lens data capturing unit 152, the ISO sensitivity limiting unit 155 limits the range of the ISO sensitivity to be manually set by the photographic condition adjusting switch 118.

The successive photography speed control unit 156 is for switching the speed or cycle of successive photography, since the speed or cycle depends on the time for winding-up a film by one frame in the case of the photography with the silver haloid film, while the speed or cycle depends on the time required for data processing such as capturing of image data and image data compression, i.e. depends on the data of the electronic imaging section, in the case when the second camera back 2 is attached to the camera body 1.

The photographic condition setting unit 154 sets photographic conditions in accordance with the photographic conditions manually set by the photographic condition adjusting switch 118 or automatically calculated by means of a program chart in accordance with light measurement, along with the data of range limitation.

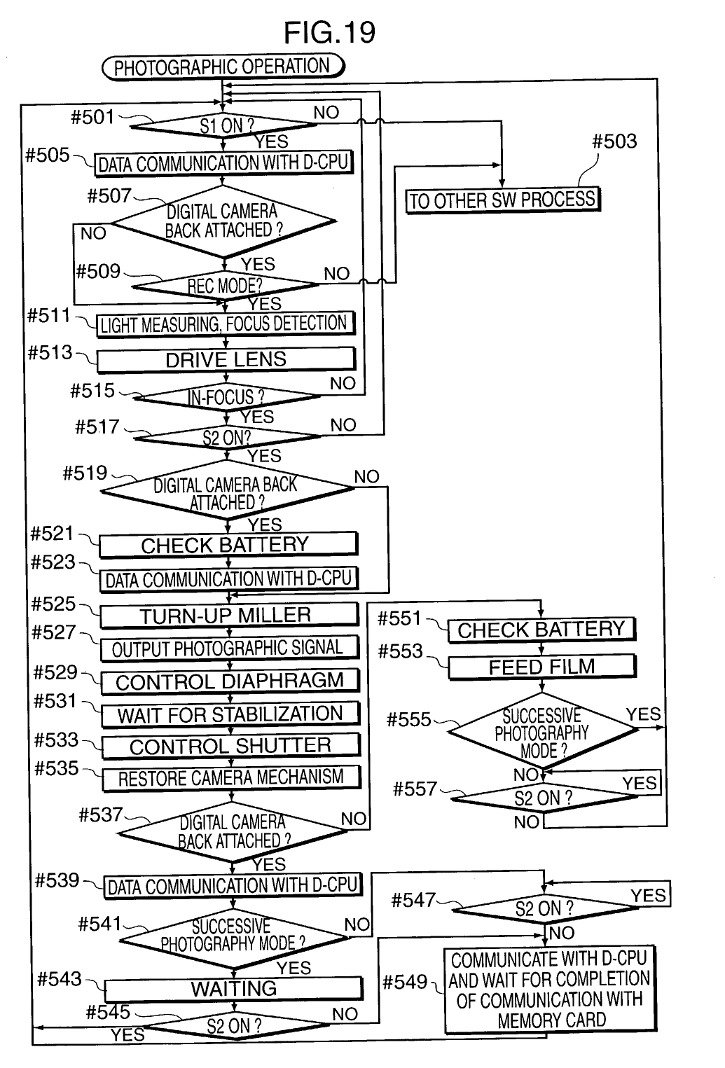

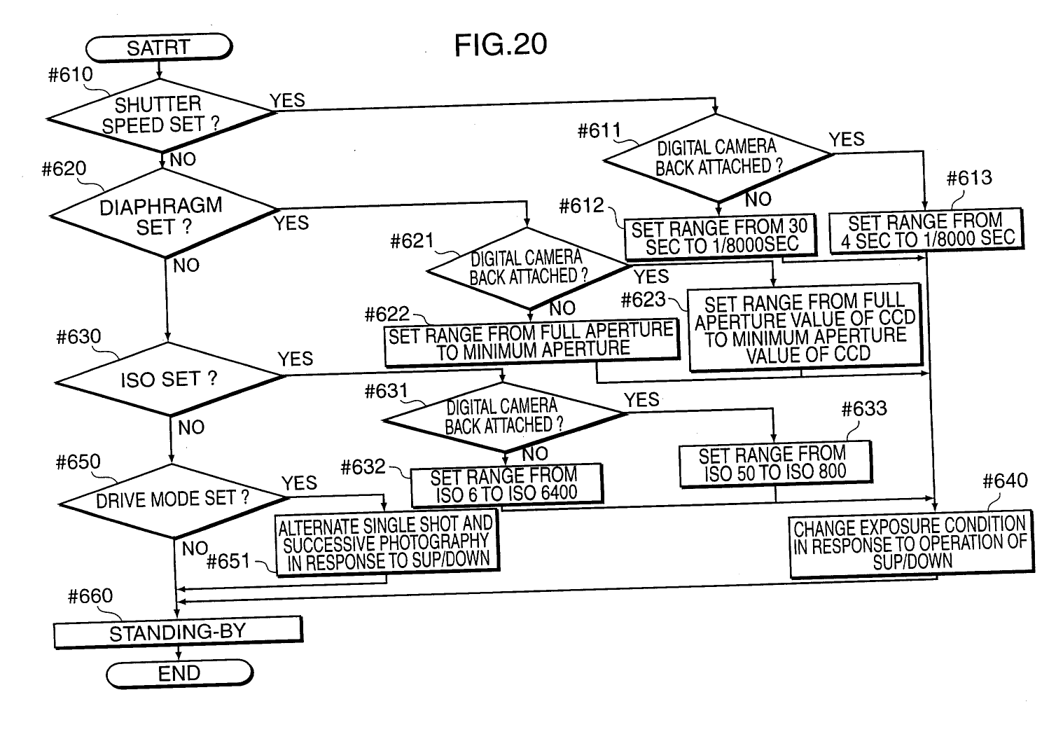

Referring to FIGS. 19 and 20, explanation will be made about the operation of the camera body 1 in the case the second camera back 2 is attached to the camera body 1. FIG. 19 is a flowchart showing an exemplary operation of the camera body 1. It is assumed here that the process explained hereinafter is executed by the camera CPU 116 and that the camera body 1, especially its CCD 116, communicates with the second camera back 2, especially its D-CPU 209, via the DX terminals 111, adjustment terminals 108 and the communication terminals 207.

First, it is determined whether the switch S1 has been turned on or not i.e. whether the light measurement and the focus detection has been initiated or not. (Step #501) When it is determined that the switch S1 has not been turned on, (No at Step #501), the flow proceed to Step #503 where a process is performed in accordance with the state of other switches. When it is determined that the switch S1 has been turned on, (Yes at Step #501), the camera CPU 116 communicate with the D-CPU (Step #505), and determines whether the second camera back 2 has been attached to the camera body 1. (Step #507) When the second camera back has not been attached to the camera body 1, the flow proceeds to Step #511. When the second camera back 2 has been attached to the camera body 1, the signal representing the state of the switch SREC is read in from the data obtained from the second camera back 2 (the data captured by the element data capturing unit 151, the data being of the electronic imaging section stored in the flash memory 205 of the second camera back 2 and including the data of the size of the CCD and the size of each pixel of the CCD), and it is determined whether the switch SREC has been turned on, i.e. whether the second camera back 2 is ready for photography. (Step #509)

When it is determined that the switch SREC has not been turned on, (No at Step #509), the flow returns back to the Step #503. When it is determined that the switch SREC has been turned on, (Yes at Step #509), a light measurement command signal is outputted to the light measuring unit 104 which executes light measuring operation, and data of the measured value is obtained. At the same time, the focus detection command signal is outputted to the focus detecting section 112 which executes focus detecting operation and the data of the detected focus condition is obtained. (Step #511) In accordance with the data of the detected focus condition, AF motor driving section 113 drives the camera objective lens (Step #513). The Steps #501 through 513 are repeated until an in-focus condition is attained. (Yes at Step #515)

When an in-focus condition is attained, it is determined whether the switch S2 has been turned on or not, i.e. whether an exposure initiating command signal has been outputted. (Step #517) When it is determined that the switch S2 has not been turned on, (No at Step #517), the flow returns to Step #501. When it is determined that the switch S2 has been turned on, (Yes at Step #517), it is then determined whether the second camera back 2 has been attached to the camera body 1. (Step #519) When the camera back 2 has been attached to the camera body 1, the battery 101 is checked. (Step #521) Then, the camera CPU 116 communicates with D-CPU 209 (Step #523), and the flow proceeds to Step #525. When the voltage of the battery 101 is lower than a predetermined level, it is determined that the camera operation is impossible until the battery is exchanged, and the flow proceeds to a standing-by or waiting sate, with that condition of the camera body 1 being informed to the D-CPU and the exposure operation being suspended. When the battery voltage is not lower than the predetermined level, the exposure initiation signal is outputted to prepare for photography. When it is determined, at Step #519, the second camera back 2 has not been attached to the camera body 1, the flow goes through to Step #525.

At Step #525, the reflex mirror is turned up to retire from the photographic light path to introduce the object light to the camera focal plane for the preparation of photographic operation. Then, an imprinting signal is outputted. (Step #527) The imprinting signal is for imprinting date on a film in case a picture is taken with a silver haloid film. The imprinting signal is used to initiate operation of the electronic imaging section and initiate picture taking operation in case when the second camera back 2 is attached to the camera body 1.

Next, the diaphragm section 115 controls the diaphragm aperture in accordance with set or determined aperture value, (Step #529), and the camera operation is suspended for a predetermined time to wait until the stopped-down diaphragm and the electronic imaging section become stable. (Step #531) After that, exposure initiation signal is outputted to the shutter section 114 and exposure is made to the silver haloid film or the electronic imaging section in the manner known in the art. (Step #533) When the photography or picture-taking operation is completed, the camera mechanism is charged again, with the shutter mechanism, diaphragm mechanism and mirror mechanism returning to their initial positions. (Step #535)

Then, it is determined whether the second camera back 2 has been attached to the camera body 1. (Step #537) When it is determined that the second camera back 2 has been attached to the camera body 1, the camera CPU 116 communicates with the D-CPU 209 to inform the completion of the exposure operation. (Step #539) It is then determined whether the camera body 1 is set at the successive photography condition. (Step #541) In the case of the successive photography condition, the camera operation is suspended to wait until all the image data have been read in from the electronic imaging section and the second camera back become ready for next exposure operation. (Step #543) When the waiting time has lapsed, it is confirmed whether the switch S2 has been turned on. When the switch S2 has been turned on, the flow returns back to Step #501 for the next exposure operation. When it is determined that the camera is not set to the successive photography condition, the camera operation is suspended to wait until the switch S2 is turned off. When the switch S2 is not in the ON condition, it is determined that the photographic operation has been completed, and the camera CPU 116 communicate with the D-CPU 209 to command the latter to write the image data in the memory card and wait until that writing operation is completed. (Step #549) In order to save power consumption, the D-CPU 209 stops the operation of the electronic imaging section 201 before the writing of the image data in the memory card is started. After that, the flow returns to Step #1.

When it is determined that the second camera back has not been attached to the camera body 1 and a picture is taken with a silver haloid film, the battery is first checked. (Step #551) When it is determined that the voltage of the battery is too low to execute photographic operation, the condition that the camera operation is unavailable, is maintained until the switch SMAIN is operated or the battery is exchanged, since the film can not be fed. When the battery voltage resumes, the film feeding are started. (Step #553) When the voltage of the battery is enough for the photographic operation, the film is fed and it is determined that the camera is set to the successive photography condition. (Step #555) In the case of the successive photography, the flow returns to Step #501. Otherwise, it is waited until the switch S2 is turned off (Step #557) and then the flow returns to Step #501.

FIG. 20 is a flow chart showing the operation for adjusting the photographic conditions. First, it is determined whether the shutter speed has been selected (for the setting of the shutter speed) by the exposure condition selection switch 116 (Step #610). When it is determined that the shutter speed has been selected, it is then determined whether the second camera back 2 has been attached to the camera body 1. (Step #611) When the second camera back 2 has not been attached to the camera body 1 but the first camera back 1 is attached for the picture-taking with a silver haloid film, the shutter speed range stored in advance, for example, 30 seconds through 1/8000 seconds is set as available shutter speed range. (Step #612) On the other hand, when the second camera back 2 has been attached to the camera body 1, the shutter speed range stored in the flash memory 205, for example 4 seconds through 1/8000 is set as the available shutter speed range. (Step #613) In the latter case, the shutter speed in the long exposure time side is limited to 4 seconds to avoid occurrence of noise.

When the shutter speed has not been selected at Step #610, it is then determined at Step #620 whether the diaphragm aperture is selected by the exposure condition selection switch 117 (for the setting of the diaphragm aperture). When it is determined at Step #620 that the diaphragm aperture has been selected, it is then determined whether the second camera back 2 has been attached to the camera body 1. (Step #621) When the second camera back 2 has not been attached to the camera body 1 but the first camera back 1 is attached for the picture-taking with a silver haloid film, the diaphragm aperture range stored in advance, i.e. the range from the full aperture to the minimum aperture, is set as available diaphragm aperture range. (Step #622) On the other hand, when the second camera back 2 has been attached to the camera body 1, a diaphragm aperture range stored in the flash memory, i.e. the range from a maximum aperture available with the CCD in use, to a minimum aperture available with the CCD in use, is set as a available diaphragm aperture range. (Step #623). In the case of the photography with the second camera back 2, the range of the diaphragm aperture is limited at both ends to avoid or reduce the effect of diffraction which occurs as the diaphragm aperture is smaller, as well as to avoid reduction of marginal lumination which occurs as the diaphragm aperture is larger towards the full aperture.

It is then determined whether ISO sensitivity is selected by the exposure condition selection switch 117 (for the setting of the ISO sensitivity). (Step #630) When it is determined at Step #630 that the ISO sensitivity has been selected, it is then determined whether the second camera back 2 has been attached to the camera body 1. (Step #631) When the second camera back 2 has not been attached to the camera body 1 but the first camera back 1 is attached for the picture-taking with a silver haloid film, the ISO sensitivity range stored in advance, for example from ISO 6 through ISO 6400 is set as available ISO sensitivity range. (Step #632) On the other hand, when the second camera back 2 has been attached to the camera body 1, the ISO sensitivity range stored in the flash memory, for example ISO 50 through ISO 800 is set as a available ISO sensitivity range. (Step #633) In the case of the photography with the second camera back 2, the ISO sensitivity range is limited to adapt for the CDD in use.

After the ranges have been set at Steps #612, #613, #622, #623, #632 and #633 as described above, respective exposure conditions or parameters selected by the exposure condition selection switch 117 is changed or adjusted in accordance with the amount or times of the up or down operation of the switch SUD (SUP/SDOWN). (Step #640) It is to be noted that the ranges are limited at Steps #612, #622 and #632. When any exposure condition is set or given to a value beyond that limited range, the set or given value may be corrected to the boundary value. Otherwise, warning may be made to the user when the set value is out of the range.

When it is determined at Step #630 that the ISO sensitivity has not been selected, the flow proceeds to Step #650 where it is determined whether a drive mode has been selected by the exposure condition selection switch 117 for the setting of the drive mode. When it is determined that the drive mode has not been selected, the flow goes to standing-by state. (Step #660) When it is determined that the drive mode has been selected, the camera is alternatively set to a one shot mode or successive photography mode in response to the operation on the switch SUD (SUP/SDOWN). (Step #651) After that the flow goes to standing-by state.

In the described embodiment, the element data includes both the data of the size of the CCD and the size of a pixel of the CCD. Instead thereof, the element data may include either of the CCD and the size of a pixel of the CCD.

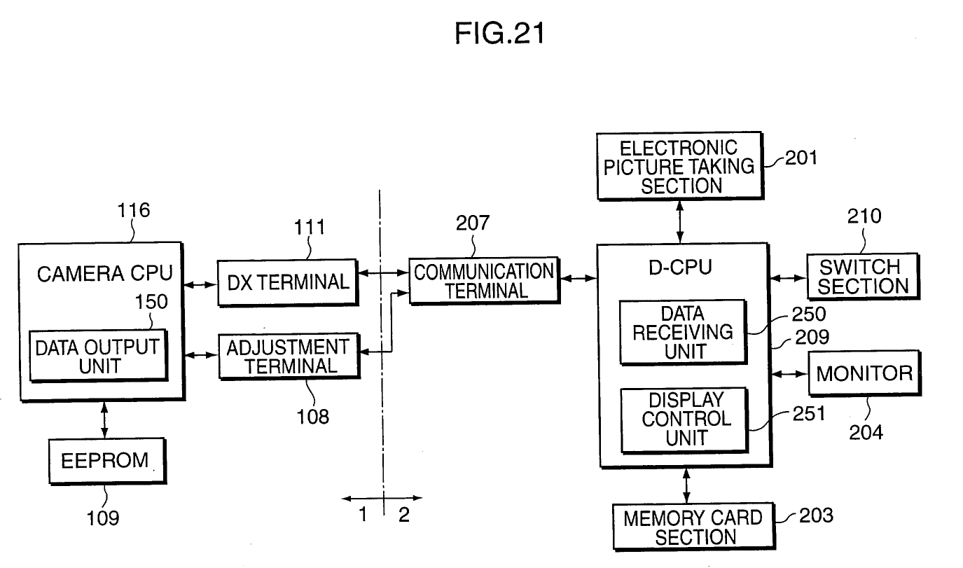

Referring now to FIGS. 21 through 24, explanation will be made about to a third embodiment of the present invention. In the Figures, same reference numerals are used for the components that are substantially the same or similar to the components of the first embodiment. It is to be noted that the main construction of the camera body and camera backs are substantially the same as those of the first embodiment and reference is to be made to the description of the first embodiment with regard to the detailed construction and operation of the common parts.

FIG. 21 is a block diagram showing main component of the camera body 1 and the second back 2 according to a third embodiment of the present invention. In the Figure, the left side of the central chain line shows the components of camera body 1 while the right side of the central chain line shows the components of the second camera back 2.

The camera body 1 comprises adjustment terminals 108 and the DX terminals for the data transmission with the second camera back 2, EEPROM for storing the data of the photographic conditions, and the camera CPU 116 which communicates with D-CPU 209 of the second camera back 2. The second camera back comprises the electronic imaging section or device 201 for forming digital image data, the memory card 203 for storing the image data and other related data, communication terminals 207 for the data transmission, D-CPU 209 for obtaining data of photographic conditions from the camera CPU 116, and switch sections 210 to be operated by the user.

The camera CPU is provided with data output unit 150 for producing photographic data from the photographic conditions, such as the shutter speed and the diaphragm aperture, and for storing the photographic data in the EEPROM109 in a lump, upon completion of exposure operation. The photographic data are also stored in the memory card through the D-CPU.

The D-CPU 209 comprises a data capturing unit 250 for capturing the image data fed from the electronic imaging section 201 and the photographic data fed from the camera CPU 116, and editing the fed data such that the photographic data are associated with the image data. The data receiving unit 250 stores the edited data in the memory card section 203. The D-CPU 209 further comprises a display control unit 251 for displaying the image of the image data and the photographic conditions of the photographic data in response to the signal from a switch section 210 when the switch of the switch section 210 is turned on to select a display mode.

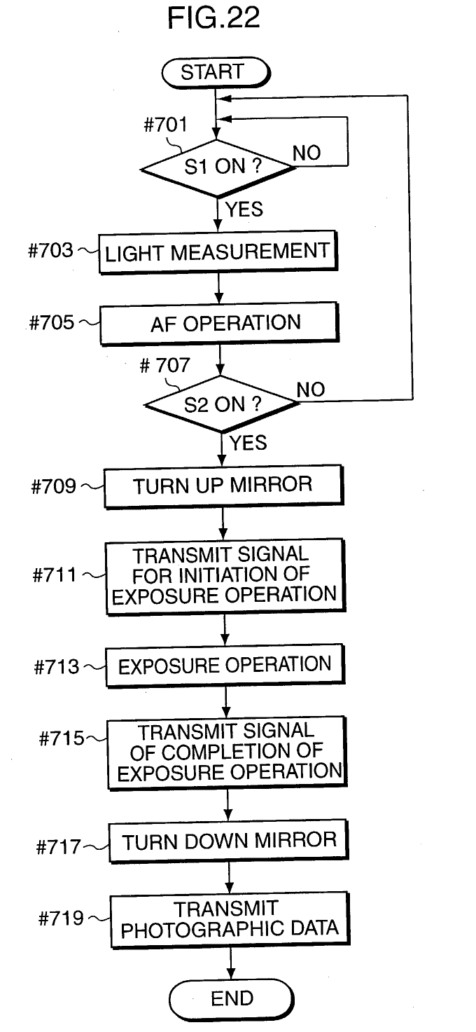

FIG. 22 is a flow chart showing an exemplary operation of the camera body 1 executed by the camera CPU 116 when the second camera back 2 is attached to the camera body 1. It is assumed here that the camera body 1, especially its CCD 116, communicates with the second camera back 2, especially its D-CPU 209, via the DX terminals 111, adjustment terminals 108 and the communication terminals 207.

First, it is determined whether or not the switch S1 has been turned on to command initiation of the light measuring and focus detecting operation. (Step #701) When it is determined that the switch S1 has not been turned on, (No at Step #701), the flow returns to Step #701 to wait until the switch S1 is turned on. When it is determined that the switch S1 has been turned on, (Yes at Step #701), an initiation command signal is fed to the light measuring section 104 which in turn executes light measuring operation for measuring the brightness of an object to be photographed, and the resultant light measurement is obtained. (Step #703) Then, an initiation command signal is fed to the focus detecting section 112 which in turn executes focus detecting operation for detecting the amount of out-of-focus of the camera objective lens, and the resultant out-of-focus measurement is obtained. Then, AF operation command signal is fed to the AF motor driving section 113 which in turn drives the camera objective lens in accordance with the out-of-focus measurement. (Step #705) Next, it is determined whether the switch S2 has been turned on to initiate exposure. (Step # 707)

When it is determined that the switch S2 has not been turned on, (No at Step #707), the flow returns to Step #701. When it is determined that the switch S2 has been turned on, (Yes at Step #707), the reflex mirror of the camera is turned up to retire from the photographic light path for the preparation of exposure. (Step #709) Then, an exposure initiation signal indicating that the camera exposure operation is to be initiated, is fed to the D-CPU 209 of the second camera back 2. (Step #711) Then, a diaphragm aperture value and a shutter speed value for the exposure is obtained and an exposure operation signal is output to the diaphragm section 115 and the shutter section 114 which in turn execute camera exposure operation. (Step #713)

When the camera exposure operation is completed, an exposure completion signal representing the completion of the camera exposure, is fed to the D-CPU 209 of the second camera back 2. (Step #715) Then, the reflex mirror is turned down to direct the object light to the view finder and the light measuring section for the preparation for the next exposure operation. (Step #717) Next, the data output unit 150 produces photographic data of the photographic conditions, such as the shutter speed and the diaphragm aperture used for the exposure, stores the photographic data in the EEPROM109, and transmits the photographic data to the D-CPU 209. (Step #719)

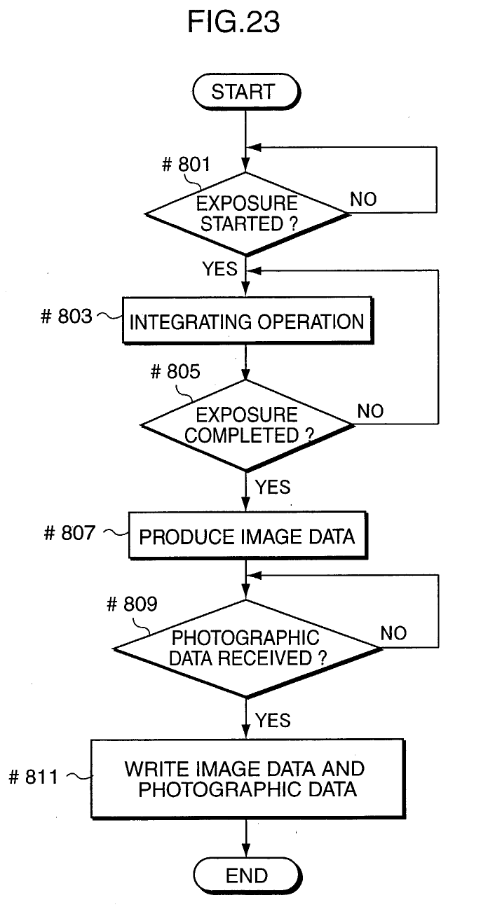

FIG. 23 is a flow chart showing an exemplary operation of the second camera back 2 attached to the camera body 1, with the operation being executed by the C-CPU 209. It is to be understood that the D-CPU 209 communicates with the camera CPU via the DX terminals 111, adjustment terminals 108 and the communication terminals 207.

First, it is determined whether the exposure initiation signal has been fed from the camera CPU 116. (Step #801) When it is determined that the exposure initiation signal has not been fed, (No at Step #801), the flow returns to Step #801 to wait until the exposure initiation signal is fed. When it is determined that the exposure initiation signal has been fed, (Yes at Step #801), the integrating operation is performed by the CCD of the electronic imaging section 201 to accumulate electric charges representing the image formed on the CCD. (Step #803)

Next, it is determined whether the exposure completion signal has been fed form the camera CPU 116. (Step #805) When it is determined that the exposure completion signal has not been fed (No at Step #805), the flow returns to Step #803 wherein the CCD of the electronic imaging section 201 continues the integrating operation until the exposure completion signal is fed. When it is determined that the exposure completion signal has been fed (Yes at Step #805), the integrating operation by the CCD is terminated and image data is produced from the accumulated charges. (Step #807)

Next, it is determined whether the photographic data have been fed form the camera CPU 116. (Step #809) When it is determined that the photographic data have not been fed, (No at Step #809), the flow returns to Step #809 to wait until the photographic data are fed. When it is determined that the photographic data have been fed, (Yes at Step #809), the data capturing unit 250 captures the photographic data, associates the photographic data with the image data taken by the electronic imaging section 201 and stores both data in the memory card 203. (Step #811)

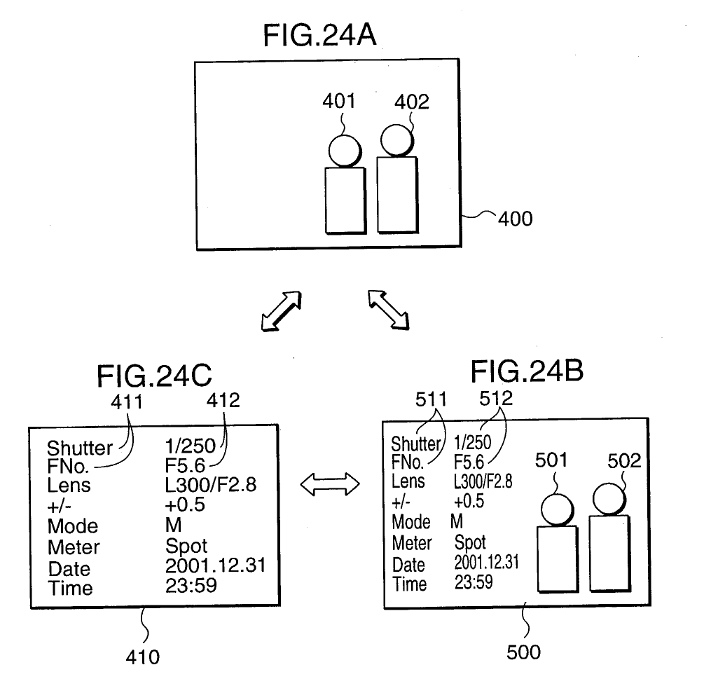

FIG. 24 shows an example of the display displayed on the monitor screen 204 by the display control unit 251. FIG. 24A shows the image display screen 400 displaying the image of the picture taken by the electronic imaging section 201. FIG. 24C shows the display screen 410 displaying the photographic data representing the photographic conditions with which the picture was taken. FIG. 24B shows the display screen 500 displaying both the image and the photographic data on the same screen.

The display screen 400 displays images of two persons 401 and 402. The display screen 410 displays the names 411 of exposure parameters on the left side and values 412 of the parameters on the right side. For example, the screen indicates that the picture was taken with the shutter speed being set at 1/250 seconds and F number (F No.) for the diaphragm aperture being set at F 5.6, by means of an objective lens having a focal length of 300 mm and full aperture value of F2.8. The mark +/− shows amount of exposure correction which is for shifting the exposure value by an amount shown, from an automatically determined value. “Mode” means whether the exposure was manually set (M) or automatically determined (A). “Meter” represents which light measuring mode was used. “Spot” represents spot light measuring. “Date” and “Time” represents the date and time when the picture was taken.

The display screen 500 displays images of two persons 501 and 502 on the right side along with the photographic data 511 and 512 on the left side. The display screens 400, 410 and 500 may be selected by the display control unit 251 in response an operation of a switch associated with a button or other manipulation member. The image data and photographic data stored in the memory card are also displayed in the same way in response to operation of a predetermined switch. According to the third embodiment, display is made of the photographic data representing the photographic condition with which a picture was taken so that the user can confirm the photographic conditions.

The third embodiment may be modified in the various way for example:

(A) In the embodiment, the communication was made through the DX terminals 111 and adjustment terminals 108 of the camera body 1 and the communication terminals 108 of the second camera back 2. The communication may be made through other type of signal/data transmission channels. For example, the camera body may be provided with a light emitting section while the second camera back may be provided with a light receiving section, so that the communication is made optically or photoelectrically with a light bearing the data and signals to be transmitted, being emitted by the camera body 1 and received by the second camera back 2. As another alternative, the camera body may be provided with an oscillator and the second camera back may be provided with a receiver such that the communication may be made by radio with a radio wave bearing the data and signals, being send by the camera body 1 and received by the second camera back 2.

(B) In the present embodiment, the communication channels are formed the DX terminals 111 and adjustment terminals 108 of the camera body 1 and the communication terminals 108 of the second camera back 2. Instead, the communication channels may be formed between the communication terminals 201 and at least one of the DX terminals 111 and adjustment terminals 108 of the camera body 1.

(C) In the present invention, the photographic data are displayed on the monitor 204 of the second camera back 2. In stead, the photographic data may be informed by electronic voice such that the user may listen to the voice message, observing the image of the take picture.

(D) In the embodiment described above, the display screen 500 is arranged to display both the image and the photographic data with the latter being superimposed on the image. The screen may be divided into two areas, one for the display of the image while the other for the display of the photographic data. In the latter case, the image and photographic data do not overlap each other and both can be shown clearly.

Having described out invention as related to the embodiments shown in the accompanying drawing, it is out intention that the invention be not limited by any of the details of description, unless otherwise specified, but rather be construed broadly within its spirit and scope as se out in the accompanying claims.

What is claimed is:

1. A camera body to be alternatively coupled with a first camera back for photography with a silver haloid film and a second camera back provided with an image pickup element for electronic photography, the camera body comprising
an element data capturing unit for capturing data of the image pickup element; and
a photographic condition control unit for controlling the determination of photographic condition in accordance with the data of the image pickup element.

2. The camera body according to claim 1, further comprising an objective lens, a lens data producing unit for producing a data relating the objective lens, and a lens data capturing unit for capturing the lens data, and wherein the photographic condition control unit controls the determination of the photographic condition in accordance with the lens data.

3. The camera body according to claim 1, wherein the data of the image pickup element include data of at least one of size of the image pickup element and size of each pixel of the image pickup element.

4. The camera body according to claim 3, further comprising an objective lens, a focus detecting unit for detecting focus condition of the objective lens in terms of a predetermined reference condition, and wherein the photographic condition control unit includes a reference condition adjusting unit for adjusting the reference condition in accordance with the data of the image pickup unit.

5. The camera body according to claim 4, wherein the focus condition detecting unit detects whether the objective lens focuses within a in-focus range, and wherein the photographic condition control unit includes a in-focus range adjusting unit for adjusting the in-focus range in accordance with the data of the image pickup unit.

6. The camera body according to claim 5, wherein the in-focus range adjusting unit adjusts the in-focus range in the manner that the in-focus range is smaller as the size of the image pickup element or the size of its pixel is smaller.

7. The camera body according to claim 3, further comprising an exposure condition setting unit for setting exposure condition, and wherein the photographic condition control unit includes a exposure condition adjusting unit for adjusting the setting of the exposure condition in accordance with the data of the image pickup element.

8. The camera body according to claim 7, wherein the exposure condition setting unit includes a light measuring unit for measuring brightness of an object to be photographed, an exposure value determining unit for determining a proper exposure value in accordance with the brightness of the object measured by the light measuring unit, a sharing coefficient producing unit for producing a sharing coefficient, and an exposure condition calculating unit for calculating a time value for shutter speed and an aperture value for diaphragm aperture in accordance with the sharing coefficient from the proper exposure value, and the exposure condition adjusting unit adjusts the sharing coefficient in accordance with the data of the image pickup unit.

9. The camera body according to claim 8, wherein the exposure condition setting unit further includes a exposure program data producing unit for producing data of exposure program, and the time value and the aperture value are determined by means of the exposure program as a function of the proper exposure value.

10. A camera body to be alternatively coupled with a first camera back for photography with a silver haloid film and a second camera back provided with an image pickup element for electronic photography, the camera body comprising
an element data capturing unit for capturing data of the image pickup element; and
exposure condition range controlling unit for controlling range of exposure conditions in accordance with the data of the image pickup element.

11. A camera body according to claim 10, wherein the exposure conditions is one of a shutter speed, a diaphragm aperture and ISO sensitivity.

12. A camera body according to claim 10, wherein the exposure condition range controlling unit makes the range of exposure conditions smaller in the case when the second camera back is attached to the camera body, than in the case when the first camera back is attached to the camera body.

13. The camera body according to claim 10, wherein the data of the image pickup element include data of at least one of size of the image pickup element and size of each pixel of the image pickup element.

14. The camera body according to claim 10 further comprising a successive photographing unit for making successive photography, and wherein the exposure condition range controlling unit controls the cycle of the successive photography in accordance with the data of the image pickup element.

15. A camera body to be alternatively coupled with a first camera back for photography with a silver haloid film and a second camera back provided with an image pickup element for electronic photography, the camera body comprising
a photographic condition determining unit for determining photographic condition;
a second camera back detecting unit for detecting whether the second camera back is attached to the camera body,
an adjustment data output section through which a data for adjustment of the camera body is outputted to an camera adjusting device, and
a photographic condition output unit for outputting the data of the photographic condition to the second camera back through the adjustment data output section.

16. A camera body according to claim 15 further comprising a film data reading unit for reading data of a film provided on a cartridge containing the film when the first camera back is attached to the camera body, and wherein a film data reading unit includes data reading terminals through which the data of film are read, and the photographic condition output unit outputs the data of the photographic condition through the data reading terminals.

17. A camera body according to claim 16, further comprising an objective lens, and wherein the adjustment data output section and the film data reading unit are arranged on opposite sides with respect to the objective lens in the transverse direction of the camera body.

18. A camera body according to claim 15, further comprising a photographic data storage unit for storing data of the photographic condition.

19. A digital photography camera back to be attached to a camera body instead of a film photography camera back, the digital photography camera back comprising:
an image pickup element for producing image data for electronic photography;
a data input section to be connected with an adjustment data output section of the camera body through which a data for adjustment of the camera body is outputted to an camera adjusting device; and
a photographic data capturing unit for capturing the data of the photographic condition from the camera body through the data input section.

20. A digital photography camera back according to claim 19, further comprising a image data storing unit for storing image data produced by the image pickup element, associating the image data with the data of the photographic condition.

21. A digital photography camera back according to claim 19, further comprising a display unit for displaying image due to the image data and the photographic condition due to the data of the photographic condition.
